(19) United States
(12) Patent Application Publication
(10) Pub. No.: US 2012/0195348 A1
(43) Pub. Date: Aug. 2, 2012

(54) Signal transmission apparatus, electronic instrument, reference signal outputting apparatus, communication apparatus, reference signal reception apparatus and signal transmission method

(75) Inventor: Masahiro Uno, Tokyo (JP)

(73) Assignee: Sony Corporation, Tokyo (JP)

(21) Appl. No.: 13/137,646

(22) Filed: Aug. 31, 2011

(30) Foreign Application Priority Data
Sep. 9, 2010 (JP) 2010-202204

(51) Int. Cl. H04B 1/7073; H04B 1/69

(52) U.S. Cl. 375/146; 375/130; 375/E01.001; 375/E01.002

(57) ABSTRACT

A signal transmission apparatus includes: a reference signal outputting section adapted to output a reference signal; a first clock production section adapted to produce, based on the reference signal, a first clock signal for a first signal process regarding a radio communication process of a spectrum spreading method in synchronism with the reference signal; a first signal processing section adapted to carry out the first signal process based on the first clock signal; a second clock production section adapted to produce, based on the reference signal, a second clock signal for a second signal process corresponding to the first signal process in synchronism with the reference signal; and a second signal processing section adapted to carry out the second signal process based on the second clock signal.

### BACKGROUND

The present disclosure relates to a signal transmission apparatus, an electronic instrument, a reference signal outputting apparatus, a communication apparatus, a reference signal reception apparatus and a signal transmission method. More specifically, the present disclosure relates to a method wherein a spectrum spreading method is applied to carry out radio communication between a plurality of communication apparatus.

A data transmission system which applies a spectrum spreading method is available. Further, as an example of transmission of a plurality of data strings in a multiplexed form, a code division multiplexing method is known wherein data strings are multiplied by code strings orthogonal to each other and added (multiplexed) and then transmitted. The code division multiplexing method is characterized in that a plurality of data strings can be multiplexed on a single carrier (refer to, for example, Japanese Patent No. 3377451).

In the code division multiplexing method, a transmission apparatus first multiplies a plurality of data strings by spread code strings orthogonal to each other and signals resulting data strings. A reception apparatus determines the spread code strings as known spread code strings and detects timings of the spread code strings in the reception signals. Then, the reception apparatus multiplies the reception signals by the known spread code strings in accordance with the timings and then integrates resulting signals within a data symbol interval to carry out despreading. Therefore, the spectrum spreading method requires a timing synchronization mechanism for spread code strings.

### SUMMARY

For timing synchronization of spread code strings, for example, a matched filter is used. However, use of a matched filter is disadvantageous in that it increases the circuit scale and the power consumption.

Therefore, it is desirable to provide a signal transmission apparatus, an electronic instrument, a reference signal outputting apparatus, a communication apparatus, a reference signal reception apparatus and a signal transmission method by which, when radio communication wherein a spectrum spreading method is applied is carried out, timing synchronism of spread code strings can be established by a simple and easy configuration.

According to a first mode of the disclosed technology, there is provided a signal transmission apparatus including a reference signal outputting section adapted to output a reference signal, a clock production section adapted to produce, based on the reference signal outputted from the reference signal outputting section, a clock signal for a signal process regarding a radio communication process of a spectrum spreading method in synchronism with the reference signal, and a signal processing section adapted to carry out the signal process based on the clock signal produced by the clock production section.

According to a second mode of the disclosed technology, there is provided a signal transmission apparatus which is a more specific form of the signal transmission apparatus according to the first mode and includes a reference signal outputting section adapted to output a reference signal, a first clock production section adapted to produce, based on the reference signal outputted from the reference signal outputting section, a first clock signal for a first signal process regarding a radio communication process of a spectrum spreading method in synchronism with the reference signal, a first signal processing section adapted to carry out the first signal process based on the first clock signal produced by the first clock production section, a second clock production section adapted to produce, based on the reference signal outputted from the reference signal outputting section, a second clock signal for a second signal process corresponding to the first signal process in synchronism with the reference signal, and a second signal processing section adapted to carry out the second signal process based on the second clock signal produced by the second clock production section.

According to a third mode of the disclosed technology, there is provided a signal transmission apparatus which is a further specific form of the signal transmission apparatus according to the first mode and includes a first signal processing section adapted to carry out a first signal process regarding a radio communication process of a spectrum spreading method based on a reference signal, a reference signal outputting section adapted to output the reference signal to be inputted to the first signal processing section, a clock production section adapted to produce, based on the reference signal outputted from the reference signal outputting section, a clock signal for a second signal process corresponding to the first signal process in synchronism with the reference signal, and a second signal processing section adapted to carry out the second signal process based on the clock signal produced by the clock production section.

According to a fourth mode of the disclosed technology, there is provided an electronic instrument including a reference signal outputting section adapted to output a reference signal, a first clock production section adapted to produce, based on the reference signal outputted from the reference signal outputting section, a first clock signal for a first signal process regarding a radio communication process of a spectrum spreading method in synchronism with the reference signal, a first signal processing section adapted to carry out the first signal process based on the first clock signal produced by the first clock production section, a second clock production section adapted to produce, based on the reference signal outputted from the reference signal outputting section, a second clock signal for a second signal process corresponding to the first signal process in synchronism with the reference signal, a second signal processing section adapted to carry out the second signal process based on the second clock signal produced by the second clock production section, a radio signal transmission line adapted to allow radio communication between the first signal processing section and the second signal processing section, and a single housing in which the reference signal outputting section, first clock production section, first signal processing section, second clock production section, second signal processing section and radio signal transmission line are accommodated.

According to a fifth mode of the disclosed technology, there is provided an electronic instrument including a first electronic instrument including a first clock production section adapted to produce, based on a reference signal, a first clock signal for a first signal process regarding a radio communication process of a spectrum spreading method in synchronism with the reference signal, a first signal processing section adapted to carry out a first signal process based on the first clock signal produced by the first clock production section, and a single housing in which the first clock production section and the first signal processing section are accommodated, and a second electronic instrument including a second clock production section adapted to produce, based on the reference signal, a second clock signal for a second signal process corresponding to the first signal process in synchronism with the reference signal, a second signal processing section adapted to carry out a second signal process based on the second clock signal produced by the second clock production section, and a single housing in which the second clock production section and the second signal processing section are accommodated, and a radio signal transmission line, which allows radio transmission between the first signal processing section and the second signal processing section, being formed when the first electronic instrument and the second electronic instrument are disposed at predetermined positions.

According to a sixth mode of the disclosed technology, there is provided an electronic instrument including a first signal processing section adapted to carry out a first signal process regarding a radio communication process of a spectrum spreading method based on a reference signal, a reference signal outputting section adapted to output the reference signal to be inputted to the first signal processing section, a clock production section adapted to produce, based on the reference signal outputted from the reference signal outputting section, a clock signal for a second signal process corresponding to the first signal process in synchronism with the reference signal, a second signal processing section adapted to carry out the second signal process based on the clock signal produced by the clock production section, a radio signal transmission line adapted to allow radio communication between the first signal processing section and the second signal processing section, and a single housing in which the first signal processing section, reference signal outputting section, clock production section, second signal processing section and radio signal transmission line are accommodated.

According to a seventh mode of the disclosed technology, there is provided an electronic instrument including a first electronic instrument including a first signal processing section adapted to carry out, based on a reference signal, a first signal process regarding a radio communication process of a spectrum spreading method, and a single housing in which the first signal processing section is accommodated, and a second electronic instrument including a clock production section adapted to produce, based on the reference signal, a clock signal for a second signal process corresponding to the first signal process in synchronism with the reference signal, a second signal processing section adapted to carry out a second signal process based on the clock signal produced by the clock production section, and a single housing in which the clock production section and the second signal processing section are accommodated, and a radio signal transmission line, which allows radio transmission between the first signal processing section and the second signal processing section, being formed when the first electronic instrument and the second electronic instrument are disposed at predetermined positions.

According to an eighth mode of the disclosed technology, there is provided a reference signal outputting apparatus including a reference signal outputting section adapted to produce a reference signal to be used for production of a clock signal for a signal process regarding a radio communication process of a spectrum spreading method and output the reference signal to a communication apparatus.

According to a ninth mode of the disclosed technology, there is provided a communication apparatus including a reference signal outputting section adapted to output a reference signal, a clock production section adapted to produce, based on the reference signal outputted from the reference signal outputting section, a clock signal for a signal process regarding a radio communication process of a spectrum spreading method in synchronism with the reference signal, and a signal processing section adapted to carry out the signal process based on the clock signal produced by the clock production section.

According to a tenth mode of the disclosed technology, there is provided a reference signal reception apparatus including a clock production section adapted to receive a reference signal to be used for production of a clock signal for a signal process regarding a radio communication process of a spectrum spreading method and produce a clock signal synchronized with the reference signal.

According to an eleventh mode of the disclosed technology, there is provided a communication apparatus including a clock production section adapted to receive a reference signal to be used for production of a clock signal for a signal process regarding a radio communication process of a spectrum spreading method and produce a clock signal synchronized with the reference signal, and a signal processing section adapted to carry out the signal process based on the clock signal produced by the clock production section.

According to a twelfth mode of the disclosed technology, there is provided a signal transmission method including receiving a reference signal to be used for production of a clock signal for a signal process regarding a radio communication process of a spectrum spreading method, producing, based on the received reference signal, a clock signal for the signal process regarding the radio communication process of the spectrum spreading method, and wirelessly transmitting a transmission object signal by the spectrum spreading method based on the produced clock signal.

In short, in the disclosed technology, a reference signal to be used for production of a clock signal for a signal process regarding a radio communication process of the spectrum spreading method is received. Then, a clock signal for the signal process regarding the radio communication process of the spectrum spreading method such as spreading of data or despreading of a reception signal is produced based on the received reference signal. Then, a transmission object signal is wirelessly transmitted by the spectrum spreading method based on the produced clock signal.

For example, the reference signal outputting section outputs a reference signal synchronized with a spread code string separately from a radio signal obtained by applying the spectrum spreading method to a transmission object signal. The clock signal production section produces a clock signal necessary for production of a spread code string and so forth in synchronism with the reference signal received from the reference signal outputting section.

When the signal processing section carries out the signal process regarding the radio communication process of the spectrum spreading method, it operates based on the clock signal synchronized with the reference signal outputted from the reference signal outputting section. Therefore, synchronism of a spread code string can be established without using a matched filter.

With the disclosed technology, when radio communication wherein the spectrum spreading method is applied is carried out, timing synthesis of a spread code string can be implemented by a simple and easy configuration. Consequently, increase of the circuit scale and the power consumption can be suppressed.

The above and other features and advantages of the disclosed technology will become apparent from the following description and the appended claims, taken in conjunction with the accompanying drawings in which like parts or elements denoted by like reference symbols.

### BRIEF DESCRIPTION OF THE DRAWINGS

FIG. 1 is a diagrammatic view showing a communication apparatus according to a working example 1;

FIG. 2 is a block diagram showing a basic configuration of a reference signal transmission apparatus shown in FIG. 1;

FIG. 3 is a block diagram showing a basic configuration of a signal transmission apparatus shown in FIG. 1;

FIGS. 4 and 5 are block diagrams illustrating different examples of general operation of a communication apparatus according to a working example 1;

FIGS. 6A and 6B are a block diagram and a timing chart illustrating a configuration and operation of a spread code string generation section shown in FIG. 4;

FIG. 7 is a timing chart illustrating general operation of the signal transmission apparatus of the working example 1;

FIG. 8 is a block diagram showing a communication apparatus according to a working example 2;

FIG. 9 is a block diagram showing a communication apparatus according to a working example 3;

FIG. 10 is a block diagram showing a signal transmission apparatus as a comparative example with those of the working examples 1 to 3;

FIG. 11 is a block diagram showing an example of a configuration of a matched filter;

FIG. 12 is a block diagram showing an example of a configuration of a despreading processing section shown in FIGS. 8 to 10;

FIG. 13 is a timing chart illustrating spreading and despreading;

FIG. 14 is a timing chart illustrating reception timing detection by the matched filter shown in FIG. 11;

FIGS. 15A and 15B are schematic views showing a first example of an electronic instrument;

FIGS. 16A to 16C are views showing a second example of an electronic instrument; and

FIGS. 17A to 17C are views illustrating a third example of an electronic instrument.

### DETAILED DESCRIPTION OF THE PREFERRED EMBODIMENT

In the following, an embodiment of the disclosed technology is described in detail with reference to the accompanying drawings. In the following description, in order to distinguish each functional element among different forms, the function element is represented by a reference character with a reference symbol of a capital letter of an alphabet like A, B, C, . . . added thereto, but when no such distinction is required, the reference symbol is omitted. This similarly applies also to the accompanying drawings.

The description is given in the following order.

1. General Outline

2. Communication Apparatus: working example 1

3. Reference Signal Transmission Apparatus

4. Signal Transmission Apparatus: transmission functioning section, reception functioning section

5. Operation of the Communication Apparatus

6. Communication Apparatus: working example 2

7. Communication Apparatus: working example 3

8. Contrast with a Comparative Example 9. Application to an Electric Apparatus: working example 4

### <General Outline>

In the following description, a signal transmission apparatus or wireless transmission apparatus which does not include a reference signal transmission apparatus is a signal transmission apparatus in a narrow sense, and a communication apparatus which includes a signal transmission apparatus in a narrow sense and a reference signal transmission apparatus is a signal transmission apparatus in a wide sense. Also it is possible to form an electronic instrument in a configuration in a state in which such apparatus as mentioned above are accommodated in a single housing. Each of such apparatus may be configured from a single apparatus or a combination of a plurality of different apparatus.

For example, in a first configuration of an embodiment which corresponds to a first mode or a twelfth mode of the disclosed technology, a signal transmission apparatus is configured from a reference signal outputting section, a clock production section and a signal processing section. The reference signal outputting section outputs a reference signal. The clock production section produces, based on the reference signal outputted from the reference signal outputting section, a clock signal for a signal process regarding a radio communication process of the spectrum spreading method in synchronism with the reference signal. The signal processing section carries out the signal process based on the clock signal produced by the clock production section.

Then, in a signal transmission method in the present embodiment, a reference signal for use for production of a clock signal for a signal process regarding a radio communication process of the spectrum spreading method is received. Then, a clock signal for the signal process regarding a radio communication process of the spectrum spreading method is produced based on the received reference signal. Then, a transmission object signal is transmitted by radio transmission in accordance with the spectrum spreading method based on the produced clock signal.

In a second configuration of the present embodiment which corresponds to a second mode of the disclosed technology, a signal transmission apparatus is configured from a reference signal outputting section, a first clock production section, a first signal processing section, a second clock production section and a second signal processing section. The reference signal outputting section outputs a reference signal. The first clock production section produces, based on the reference signal outputted from the reference signal outputting section, a first clock signal for a first signal process regarding a radio communication process of a spectrum spreading method in synchronism with the reference signal. The first signal processing section carries out the first signal process based on the first clock signal produced by the first clock production section. The second clock production section produces, based on the reference signal outputted from the reference signal outputting section, a second clock signal for a second signal process corresponding to the first signal process in synchronism with the reference signal. The second signal processing section carries out the second signal process based on the second clock signal produced by the second clock production section.

In this instance, the first signal processing section may include a first spread code string generation section adapted to produce a first spread code string in synchronism with the first clock signal produced by the first clock production section, and a spreading processing section adapted to carry out a spreading process of transmission object data based on the first spread code string produced by the first spread code generation section as the first signal process. Meanwhile, the second signal processing section may include a second spread code string generation section adapted to produce a second spread code string in synchronism with the second clock signal produced by the second clock production section, and a despreading processing section adapted to carry out a despreading process of reception data based on the second spread code string produced by the second spread code string generation section as the second signal process.

In a third configuration of the present embodiment which corresponds to a third mode of the disclosed technology, a signal transmission apparatus is configured from a first signal processing section, a reference signal outputting section, a clock production section and a second signal processing section. The first signal processing section carries out a first signal process regarding a radio communication process of a spectrum spreading method based on a reference signal. The reference signal outputting section outputs the reference signal to be inputted to the first signal processing section. The clock production section produces, based on the reference signal outputted from the reference signal outputting section, a clock signal for a second signal process corresponding to the first signal process in synchronism with the reference signal. The second signal processing section carries out the second signal process based on the clock signal produced by the clock production section.

In this instance, the first signal processing section may include a first spread code string generation section adapted to produce a first spread code string in synchronism with the reference signal, and a spreading processing section adapted to carry out a spreading process of transmission object data base on the first spread code string produced by the first spread code string generation section as the first signal process. Meanwhile, the second signal processing section may include a second spread code string generation section adapted to produce a second spread code string in synchronism with the clock signal produced by the clock production section, and a despreading processing section adapted to carry out a despreading process of reception data based on the second spread code string produced by the second spread code string generation section as the second signal process.

In any of the first to third configurations of the present embodiment, preferably the first clock production section, second clock production section, or clock production section carries out phase correction in accordance with a correction amount determined based on a communication environment characteristic.

In any of the first to third configurations of the present embodiment, preferably the first clock production section, second clock production section, or clock production section produces a clock signal of a symbol period based on the reference signal outputted from the reference signal outputting section. Incidentally, in this instance, only it is necessary to produce a clock signal of the symbol period based on the reference signal, and although the symbol period and the frequency of the reference signal may be different from each other, preferably the reference signal outputting section outputs the reference signal having a frequency equal to the frequency of the symbol period.

In any of the first to third configurations of the present embodiment, preferably the signal transmission apparatus further includes a modulation section including a first carrier signal production section for producing a first carrier signal and adapted to modulate the signal outputted from the first signal processing section with the first carrier signal produced by the first carrier signal production section, and a demodulation section including a second carrier signal production section for producing a second carrier signal and adapted to demodulate a signal outputted from the modulation section with the second carrier signal produced by the second carrier signal production section, at least one of the first carrier signal production section and the second carrier signal production section producing, based on the reference signal outputted from the reference signal outputting section, the carrier signal in synchronism with the reference signal. In this instance, preferably at least one of the first carrier signal production section and the second carrier signal production section produces the carrier signal in synchronism with the reference signal by an injection locking method.

In a fourth configuration of the present embodiment which corresponds to a fourth mode of the disclosed technology, an electronic instrument is configured from a reference signal outputting section, a first clock production section, a first signal processing section, a second clock production section, a second signal processing section, a radio signal transmission line adapted to allow radio communication between the first signal processing section and the second signal processing section, and a single housing in which the components mentioned are accommodated. The reference signal outputting section outputs a reference signal. The first clock production section produces, based on the reference signal outputted from the reference signal outputting section, a first clock signal for a first signal process regarding a radio communication process of a spectrum spreading method in synchronism with the reference signal. The first signal processing section carries out the first signal process based on the first clock signal produced by the first clock production section. The second clock production section produces, based on the reference signal outputted from the reference signal outputting section, a second clock signal for a second signal process corresponding to the first signal process in synchronism with the reference signal. The second signal processing section carries out the second signal process based on the second clock signal produced by the second clock production section.

In a fifth configuration of the present embodiment which corresponds to a fifth mode of the disclosed technology, an electronic instrument is configured from a first electronic instrument and a second electronic instrument. Further, a radio signal transmission line, which allows radio transmission between the first signal processing section and the second signal processing section, is formed when the first electronic instrument and the second electronic instrument are disposed at predetermined positions. The first electronic instrument includes a first clock production section adapted to produce, based on a reference signal, a first clock signal for a first signal process regarding a radio communication process of a spectrum spreading method in synchronism with the reference signal, a first signal processing section adapted to carry out a first signal process based on the first clock signal produced by the first clock production section, and a single housing in which the first clock production section and the first signal processing section are accommodated. The second electronic instrument includes a second clock production section adapted to produce, based on the reference signal, a second clock signal for a second signal process corresponding to the first signal process in synchronism with the reference signal, a second signal processing section adapted to carry out a second signal process based on the second clock signal produced by the second clock production section, and a single housing in which the second clock production section and the second signal processing section are accommodated. In this instance, although a reference signal outputting section adapted to output the reference signal, or a reference signal outputting apparatus which includes the reference signal outputting section, may be provided externally of the first electronic instrument or the second electronic instrument, preferably the reference signal outputting section is accommodated in the housing of one of the first electronic instrument and the second electronic instrument.

In a sixth configuration of the present embodiment which corresponds to a sixth mode of the disclosed technology, an electronic instrument is configured from a first signal processing section, a reference signal outputting section, a clock production section, a second signal processing section, a radio signal transmission line adapted to allow radio communication between the first signal processing section and the second signal processing section, and a single housing in which the components mentioned are accommodated. The first signal processing section carries out a first signal process regarding a radio communication process of a spectrum spreading method based on a reference signal. The reference signal outputting section outputs the reference signal to be inputted to the first signal processing section. The clock production section produces, based on the reference signal outputted from the reference signal outputting section, a clock signal for a second signal process corresponding to the first signal process in synchronism with the reference signal. The second signal processing section carries out the second signal process based on the clock signal produced by the clock production section.

In a seventh configuration of the present embodiment which corresponds to a seventh mode of the disclosed technology, the electronic instrument includes a first electronic instrument and a second electronic instrument. Further, a radio signal transmission line, which allows radio transmission between the first signal processing section and the second signal processing section, is formed when the first electronic instrument and the second electronic instrument are disposed at predetermined positions. The first electronic instrument includes a first signal processing section adapted to carry out, based on a reference signal, a first signal process regarding a radio communication process of a spectrum spreading method, and a single housing in which the first signal processing section is accommodated. The second electronic instrument includes a clock production section adapted to produce, based on the reference signal, a clock signal for a second signal process corresponding to the first signal process in synchronism with the reference signal, a second signal processing section adapted to carry out a second signal process based on the clock signal produced by the clock production section, and a single housing in which the clock production section and the second signal processing section are accommodated. In this instance, although a reference signal outputting section adapted to output the reference signal, or a reference signal outputting apparatus which includes the reference signal outputting section, may be provided externally of the first electronic instrument or the second electronic instrument, preferably the reference signal outputting section or the reference signal outputting apparatus which includes the reference signal outputting section is accommodated in the housing of one of the first electronic instrument and the second electronic instrument.

In an eighth configuration of the present embodiment which corresponds to an eighth mode of the disclosed technology, a reference signal outputting apparatus is configured from a reference signal outputting section adapted to produce a reference signal to be used for production of a clock signal for a signal process regarding a radio communication process of a spectrum spreading method and output the reference signal to a communication apparatus. Further, in a ninth configuration of the present embodiment which corresponds to a ninth mode of the disclosed technology, a communication apparatus is configured from a reference signal outputting section adapted to output a reference signal, a clock production section adapted to produce, based on the reference signal outputted from the reference signal outputting section, a clock signal for a signal process regarding a radio communication process of a spectrum spreading method in synchronism with the reference signal, and a signal processing section adapted to carry out the signal process based on the clock signal produced by the clock production section. In short, the reference signal outputting apparatus can be formed integrally with the communication apparatus. In other words, the communication apparatus may include a reference signal outputting section adapted to output a reference signal, a clock production section, and a signal processing section. In this instance, the clock production section produces, based on the reference signal outputted from the reference signal outputting section, a clock signal for a signal process regarding a radio communication process of the spectrum spreading method in synchronism with the reference signal. The signal processing section carries out the signal process regarding the radio communication process of the spectrum spreading method based on the clock signal produced by the clock production section.

In a tenth configuration of the present embodiment which corresponds to a tenth mode of the disclosed technology, a reference signal reception apparatus is configured from a clock production section adapted to receive a reference signal to be used for production of a clock signal for a signal process regarding a radio communication process of a spectrum spreading method and produce a clock signal synchronized with the reference signal. Meanwhile, in an tenth configuration of the present embodiment which corresponds to a tenth mode of the disclosed technology, a communication apparatus is configured from a clock production section adapted to receive a reference signal to be used for production of a clock signal for a signal process regarding a radio communication process of a spectrum spreading method and produce a clock signal synchronized with the reference signal, and a signal processing section adapted to carry out the signal process based on the clock signal produced by the clock production section. In short, the reference signal reception apparatus can be formed integrally with the communication apparatus. In other words, the communication apparatus may include a clock production section, and a signal processing section. In this instance, the clock production section receives a reference signal to be used for production of a clock signal for a signal process regarding a radio communication process of the spectrum spreading method, and produces a clock signal synchronized with the reference signal. The signal processing section carries out the signal process regarding the radio communication process of the spectrum spreading method based on the clock signal produced by the clock production section.

### Working Example 1

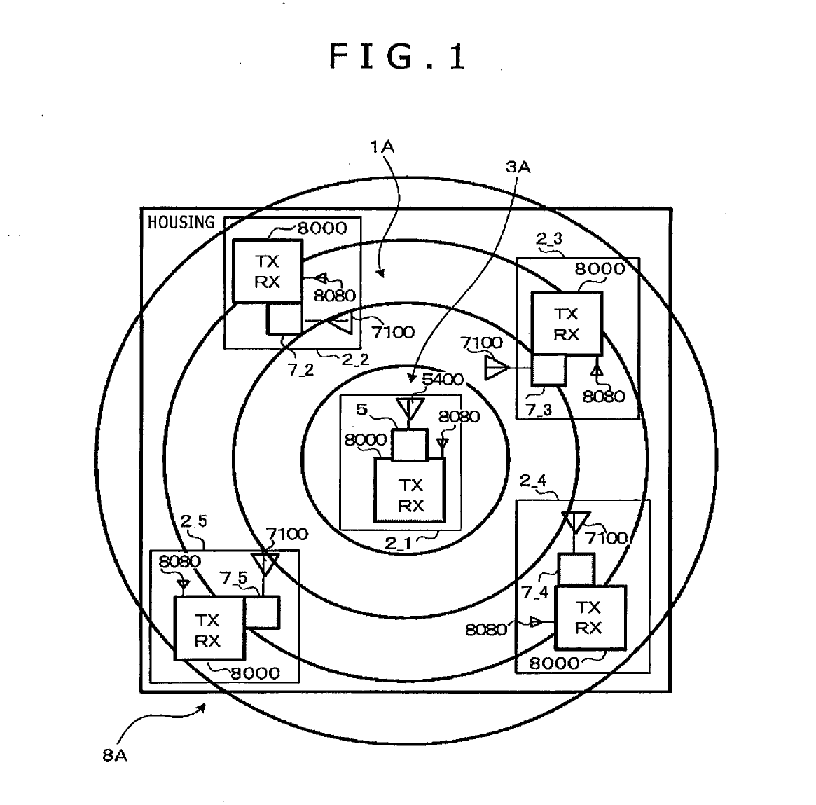

FIG. 1 shows a communication apparatus according to a working example 1 of the disclosed technology. The working example 1 is an example wherein a reference signal transmission apparatus 3A is applied to a signal transmission apparatus 1A to configure a communication apparatus 8A.

Referring to FIG. 1, the communication apparatus 8A of the working example 1 includes a signal transmission apparatus 1A which in turn includes a plurality of communication devices 2 for transmitting a transmission object signal by wireless transmission, and a reference signal transmission apparatus 3A. A communication device 2 on the transmission side is hereinafter referred to as transmitter while a communication device 2 on the reception side is hereinafter referred to as receiver.

The signal transmission apparatus 1 carries out communication adopting the spectrum spreading method. The carrier frequency may be selected from within the millimeter waveband. Or, the submillimeter waveband of a shorter wavelength of 0.1 to 1 mm may be used in place of the millimeter waveband. The following Reference Document 1 may be referred to as a reference document for a code multiplexing method:
Reference Document 1: Proakis, “Digital Communication,” particularly Chapter 13, Spread Spectrum Signals for Digital Communication, McGraw-Hill

The communication device 2 includes a communication chip 8000. The communication chip 8000 may be formed from one or both of a sender chip 8001 (TX) and a receiver chip 8002 (RX) hereinafter described or may be formed as one chip including functions of both of the sender chip 8001 and the receiver chip 8002 so as to be ready for bidirectional communication. In a preferred mode, the communication chip 8000 and a reference signal reception apparatus 7 are incorporated in the communication device 2 as seen in FIG. 1. However, it is not limited to this. Further, while, in the example shown in FIG. 1, the communication chip 8000 and the reference signal reception apparatus 7 are represented as separate functioning sections, another configuration may be adopted wherein the communication chip 8000 includes all or some of functioning sections of the reference signal reception device 7.

The reference signal transmission apparatus 3A in the working example 1 includes a reference signal transmission device 5 for sending a reference signal to be used by the communication device 2, in the present example, a signal which is used as a reference to a timing signal for spread code strings and so forth, and a reference signal reception device 7 provided for each communication device 2. The reference signal transmission device 5 is an example of the reference signal outputting apparatus.

In the example shown in FIG. 1, five communication devices 2_1 to 2_5, one reference signal transmission device 5 accommodated in the communication device 2_1, and four reference signal reception devices 7_2 to 7_5 accommodated in the communication devices 2_2 to 2_5, respectively, are accommodated in a housing of one electronic instrument. However, the number of such communication devices 2 and the reference signal reception devices 7 is not limited to 4 or 5, and they need not essentially be accommodated in a housing of one electronic instrument.

A spread code string, that is, a spread code periodic signal, is a reference clock having a period of Tsym corresponding to the data symbol period length of a transmission object signal and is referred to also as symbol periodic signal Sig1. The spread code rate of the spread code string is T chips/second (chips/s), and the spread rate to the symbol periodic signal Sig1 is represented by SF. When communication is carried out adopting the spectrum spreading method, the reference signal transmission device 5 transmits a reference signal, hereinafter referred to also as reference clock, of a frequency same as that of the symbol periodic signal Sig1.

At this time, in the example shown in FIG. 1, radio frequencies of a transmission object signal between the communication devices 2 and a reference signal between each communication device 2 and the reference signal transmission device 5 are different from each other. Therefore, the communication devices 2 use different antennae, that is, antennae 5400, 7100 and 8080 for a radio signal for a transmission object signal and a radio signal for a reference signal. However, this is not essentially required. For example, taking notice of the fact that the communication devices 2, reference signal transmission device 5 and reference signal reception devices 7 transmit and receive synchronized signals, a single antenna may be used commonly for the signals.

In the signal transmission apparatus 1, the reference signal transmission device 5 first signals a reference clock or reference signal by radio, and this reference clock is received by the communication devices 2 including the transmitter and a receiver. In particular, the reference signal transmission device 5 produces another reference clock synchronized with the reference clock or symbol periodic signal Sig1 and transmits the produced reference clock to the reference signal reception device 7 provided corresponding to each of the other communication device 2 separately from the transmission signal.

The reference signal reception device 7 provided for each communication device 2 produces a symbol periodic signal Sig1 synchronized with the received reference clock of the symbol period Tsym and a clock of a spread code rate of T chips/second. Then, the communication device 2 produces spread code strings in synchronism with the reference clock signaled from the reference signal transmission device 5 or clock signaling device, and carries out a spreading process or a despreading process based on the spread code process.

In communication to which the spectrum spreading method is applied, it is necessary to establish synchronism in timing between the transmission side and the reception side. When the spectrum spreading method is adopted to carry out radio communication, in a mode in which the communication environment is fixed to some degree as in communication within an apparatus or in communication between apparatus at a short distance, preferably an event different from that in normal outdoor communication is taken into consideration.

For example, different from outdoor communication such as, for example, cellular communication, the communication to which the spectrum spreading method is applied is characterized in 1) that the situation of the propagation path does not vary, 2) that a reception power fluctuation or a timing fluctuation does not substantially occur or occurs but by a very small amount, 3) that the propagation distance is short, 4) that the multipath delay spread is small, and 5) that there is no necessity to use a pseudo random string for the spread code. The characteristics 1) to 5) are hereinafter referred to collectively as characteristics in “intra-apparatus or inter-apparatus radio communication.” In “intra-apparatus or inter-apparatus radio communication,” there is no necessity to always check a situation of the transmission path as in ordinary spread spectrum communication.

Therefore, a reference clock is transmitted from the reference signal transmission device 5 to each reference signal reception device 7 and received by the reference signal reception device 7. In each communication apparatus 2, the reference signal reception device 7 can produce a timing signal for a code division multiplexing process based on the received reference clock. Then, the communication device 2 can establish code timing synchronism described hereinabove by carrying out timing correction based on a transmission delay checked already or on other communication environment characteristics. Since a complicated technique such as a matched filter need not be used, the circuit scale and the power consumption of the communication device 2 can be reduced.

Further, the “intra-apparatus or inter-apparatus wireless transmission” may be regarded as wireless signal transmission in a static environment, and the communication environment characteristic may be regarded as substantially invariable. This signifies that, “since the communication environment is invariable or fixed, also parameter setting may be invariable or fixed.” Therefore, a parameter representative of a communication environment characteristic may be determined and stored into a storage device such as a memory, for example, upon shipment of the product, such that, upon operation, phase correction is executed based on the parameter. In the case of the present example, although a phase correction mechanism is installed, since a mechanism for normally supervising the communication environment characteristic and carrying out phase correction based on a result of the supervision is not required, the circuit scale can be made small and the power consumption can be reduced.

### <Reference Signal Transmission Apparatus>

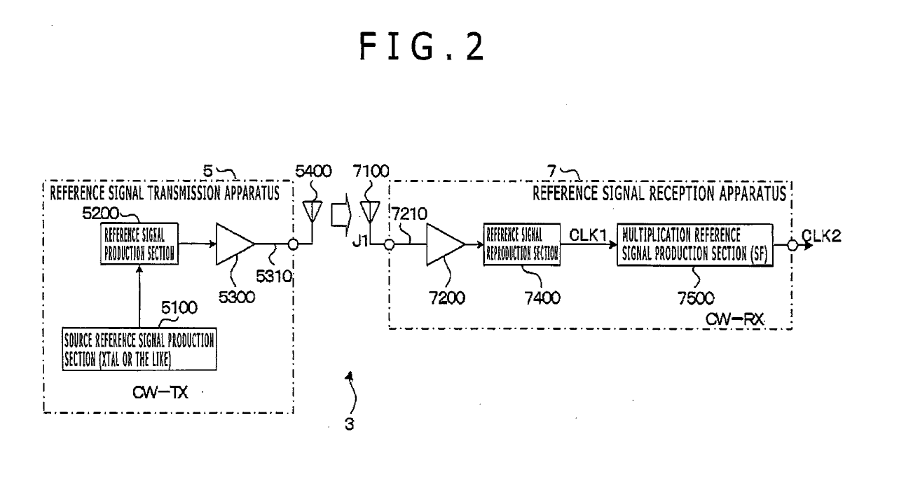

FIG. 2 shows a basic configuration of the reference signal transmission apparatus 3. Referring to FIG. 2, the reference signal transmission device 5 (CW-TX) includes a source reference signal outputting section 5100, a reference signal production section 5200, which is an example of the reference signal outputting section, an amplification section 5300, and an antenna 5400.

The source reference signal outputting section 5100 produces a timing signal referred to as source reference signal J0 which is used as a reference to the entire apparatus. In the source reference signal outputting section 5100, as an example, the source reference signal J0 of a frequency fck is generated by a quartz oscillator (XTAL) or the like.

The reference signal production section 5200 produces a reference timing signal for transmission, that is, a high frequency reference signal, by multiplying the frequency of the source reference signal J0 to a frequency of the symbol period Tsym. In other words, the reference signal production section 5200 converts the source reference signal J0 into a reference signal J1 of a higher frequency. The reference signal J1 is an example of the high frequency reference signal, and the reference signal production section 5200 is an example of the high frequency reference signal outputting section which produces, based on the source reference signal J0 produced by the source reference signal outputting section 5100, a high frequency reference signal of a higher frequency, that is, the reference signal J1. The reference signal production section 5200 may be any circuit only if it can produce a high frequency reference signal of a frequency higher than that of the source reference signal J0, that is, can produce the reference signal J1, and may take various circuit configurations. However, the reference signal production section 5200 is preferably configured from, for example, a PLL (Phase-Locked Loop) circuit, a DLL (Delay-Locked Loop) circuit or a like circuit. The reference signal production section 5200 may produce the reference signal J1 as a non-modulated carrier by modulating a carrier signal with the source reference signal J0.

The amplification section 5300 amplifies the reference signal J1 after the frequency conversion, that is, having a frequency of the symbol period Tsym and supplies the amplified reference signal J1 to a transmission line coupling section 5310, which is, for example, a microstrip line, connected to the antenna 5400.

The reference signal reception apparatus 7 (CW-RX) includes an antenna 7100, an amplification section 7200, a reference signal reproduction section 7400 and a multiplication reference signal production section 7500. A reference signal J1 received by the antenna 7100 is supplied to the amplification section 7200 through a transmission line coupling section 7210 which may be, for example, a microstrip line. The amplification section 7200 amplifies and supplies the reference signal J1 to the reference signal reproduction section 7400.

The reference signal reproduction section 7400 extracts a reference signal CLK1 having a frequency and a phase fully same as those of the reference signal J1 on the transmission side, that is, synchronized in frequency and in phase, and supplies the reference signal CLK1 to the multiplication reference signal production section 7500.

The multiplication reference signal production section 7500 multiplies the frequency of the reference signal CLK1 reproduced by the reference signal reproduction section 7400 to SF times to produce a multiplication reference signal CLK2 of a spread code rate of T chips/second which serves as a reference to a code spreading process and a code despreading process. The multiplication reference signal CLK2 is an example of the high frequency reference signal, and the multiplication reference signal production section 7500 is an example of the high frequency reference signal outputting section for producing, based on a high frequency reference signal produced by the reference signal production section 5200, that is, based on the reference signal J1, a high frequency reference signal of a higher frequency.

The reference signal reception device 7 having such a configuration as described above configures a reference signal receiver wherein the reference signal J1 is received by the antenna 7100 and the reference signal CLK1 reproduced by the reference signal reproduction section 7400 is further multiplied by the multiplication reference signal production section 7500 to reproduce the multiplication reference signal CLK2. The reference signal CLK1 and the multiplication reference signal CLK2 are collectively referred to as reference signals REFCLK. The reference signal transmission apparatus 3 configured from such a reference signal transmission device 5 and a reference signal reception device 7 as described above can transmit reference signals synchronized in frequency with each other by radio transmission.

Since the reference signal J1 is transmitted to several places by radio transmission, no electric wiring line is required, and the reference signal J1 can be supplied to various places while solving the problems of signal distortion and unnecessary radiation. Since the multiplication reference signal CLK2 for a frequency necessary for various places can be prepared based on the reference signal CLK1, the frequency which can be used as a reference signal can be made compatible with the various communication devices 2.

Although the functioning section which multiplies the frequency of the reference signal CLK1 to SF times is provided on the reference signal reception device 7 side, a same functioning section may be provided on the communication device 2 without providing the functioning section on the reference signal reception device 7 side. Or, the multiplication reference signal production section 7500 may be provided in the reference signal reception device 7 while a functioning section for implementing a different multiplication number is provided on the communication device 2 side. In this instance, the multiplication number of the entire apparatus is set to SF.

### <Wireless Transmission Apparatus>

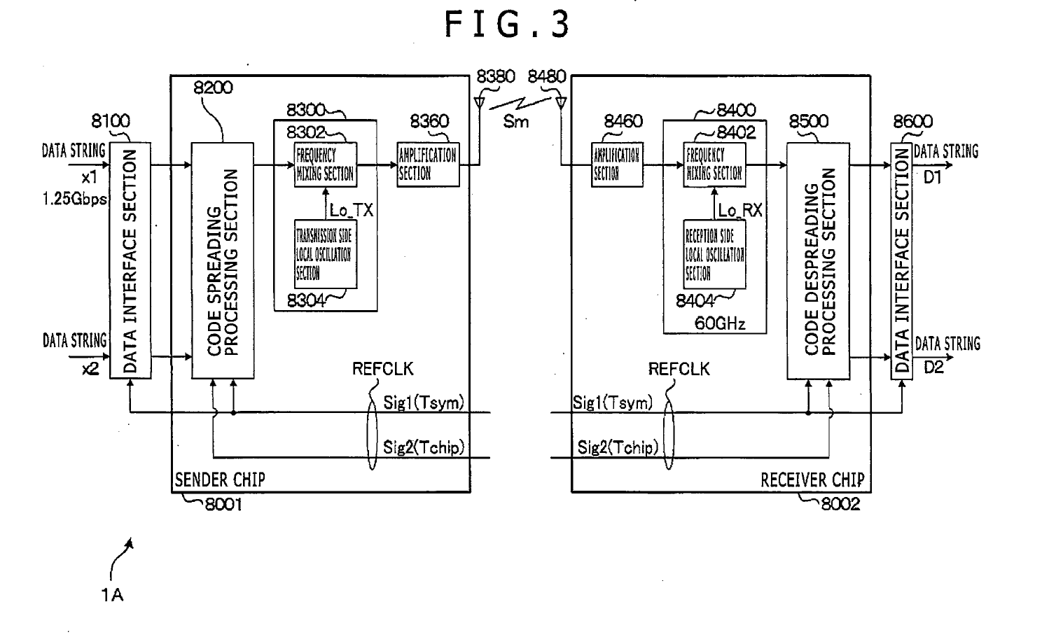

FIG. 3 shows a basic configuration of the signal transmission apparatus 1A. Referring to FIG. 3, the signal transmission apparatus 1A which is a communication apparatus is basically configured from a sender chip 8001 (TX) and a receiver chip 8002 (RX) which use a reference signal REFCLK, and a data interface section 8100 and a data interface section 8600 provided on the front and rear sides of the sender chip 8001 and the receiver chip 8002, respectively. The sender chip 8001 includes a code spreading processing section 8200 which is an example of the first signal processing section, and a modulation functioning section 8300. The receiver chip 8002 includes a demodulation functioning section 8400 and a code despreading processing section 8500, which is an example of the second signal processing section. To the code spreading processing section 8200 and the code despreading processing section 8500, the symbol periodic signal Sig1 and a spread code rate signal Sig2 are supplied as the reference signals REFCLK, respectively, from the clock production section not shown. Here, in the present configuration, the reference signal reception device 7 is utilized as a clock production section as described hereinabove.

### Data Interface Section: Transmission Side

The data interface section 8100 on the transmission side receives a first data string x1 and a second data string x2 supplied thereto and transfers them to the sender chip 8001, particularly to the code spreading processing section 8200. For example, data of 1.25 gigabits/second (Gbps) are supplied to the code spreading processing section 8200 through the data interface section 8100. As a modification, the data interface section 8100 may otherwise receive a reference clock supplied thereto in place of the second data string x2 and supply the reference clock to the sender chip 8001 (refer to the working example 2 hereinafter described).

### Code Spreading Processing Section

The code spreading processing section 8200 on the transmission side uses the symbol periodic signal Sig1 and the spread code rate signal Sig2 supplied thereto from the reference signal reception device 7 not shown to multiply the two first data string x1 and second data string x2 by two spread code strings orthogonal to each other and then add and pass the products to the modulation functioning section 8300.

### Modulation Functioning Section

A signal of a transmission object, which is a baseband signal and is an image signal of, for example, 12 bits, is converted into a high speed serial data string by a signal production section not shown and is then supplied to the modulation functioning section 8300. The modulation functioning section 8300 is an example of the signal processing section which carries out signal processing based on the multiplication reference signal CLK2 which is a low frequency reference signal and modulates the signal of the transmission object into a signal in the millimeter waveband in accordance with a modulation method determined in advance using a signal from the parallel-serial conversion section as a modulation signal.

The modulation functioning section 8300 can take various circuit configurations in response to the modulation method, but may be configured adopting a configuration which includes a 2-input type frequency mixing section 8302, also referred to frequency conversion section, mixer circuit, multiplier or the like, and a transmission side local oscillation section 8304 which is a first carrier signal production section. The frequency mixing section 8302 modulates a signal outputted from the code spreading processing section 8200 with a carrier signal Lo_TX produced by the transmission side local oscillation section 8304.

The transmission side local oscillation section 8304 produces a carrier signal Lo_TX for use for modulation, which is a modulation carrier signal. The transmission side local oscillation section 8304 is an example of the second high frequency reference signal outputting section which produces a carrier signal, which is an example of the second high frequency reference signal, of a higher frequency synchronized with the multiplication reference signal CLK2 produced by the reference signal reproduction section 7400. The transmission side local oscillation section 8304 may be any oscillation section only if it produces the carrier signal Lo_TX based on the multiplication reference signal CLK2_TX and can take various circuit configurations. However, it is suitable to configure the transmission side local oscillation section 8304, for example, from a PLL or a DLL.

The frequency mixing section 8302 multiplies or modulates the signal from the parallel to serial conversion section by the carrier signal Lo_TX in the millimeter waveband generated by the transmission side local oscillation section 8304 to produce a transmission signal or modulated signal of the millimeter waveband. The produced transmission signal is supplied to an amplification section 8360. The transmission signal is amplified by the amplification section 8360 and radiated as a radio signal Sm in the millimeter waveband from a transmission antenna 8380.

### Demodulation Functioning Section

The demodulation functioning section 8400 can be formed adopting various circuit configurations within a range corresponding to the modulation method of the transmission side and is formed using, at least, a circuit configuration compatible with the modulation method of the modulation functioning section 8300. The demodulation functioning section 8400 is an example of the signal processing section which carries out signal processing based on the multiplication reference signal CLK2 which is a low frequency reference signal. The demodulation functioning section 8400 includes a frequency mixing section 8402 of the two-input type, also referred to as frequency conversion section, mixer circuit, multiplier or the like, and a reception side local oscillation section 8404 which is the second carrier signal production section. The demodulation functioning section 8400 carries out signal demodulation by a synchronous detection method from the reception signal received by an antenna 8236.

The frequency mixing section 8402 demodulates a signal outputted from an amplification section 8460 with a carrier signal Lo_RX produced by the reception side local oscillation section 8404. Though not shown, a low-pass filter (LPF) may be provided at the succeeding stage to the frequency mixing section 8402 such that high-frequency components included in the multiplication output are removed. In the synchronous detection method, the carrier is reproduced by the reception side local oscillation section 8404 separate from the frequency mixing section 8402, and demodulation is carried out utilizing the reproduction carrier. In communication which uses synchronous detection, it is necessary for the carrier signals for transmission and reception to be in synchronism with each other in frequency and phase.

The reception side local oscillation section 8404 is an example of the second high frequency reference signal outputting section which produces a carrier signal of a higher frequency, which is an example of the second high frequency reference signal, synchronized with the multiplication reference signal CLK2 produced by the reference signal reproduction section 7400. The reception side local oscillation section 8404 may be any circuit only if it produces a carrier signal based on the multiplication reference signal CLK2_RX and can take various circuit configurations. The reception side local oscillation section 8404 is suitably configured, for example, from a PLL, a DLL or the like.

### Code Despreading Processing Section

The code despreading processing section 8500 on the reception side uses the symbol periodic signal Sig1 and the spread code rate signal Sig2 supplied thereto from the reference signal reception device 7 not shown to detect of a timing of a known spread code string in a reception signal in the form of a baseband signal demodulated by the demodulation functioning section 8400. Then, the code despreading processing section 8500 multiplies the reception signal by the spread code string and integrates the sum to carry out despreading, and then passes a result of the despreading to the data interface section 8600. Therefore, according to the spectrum spreading method, a code synchronizing mechanism is required.

### Interface Section: Reception Side

The data interface section 8600 on the reception side receives a first data string D1 and a second data string D2 supplied thereto from the receiver chip 8002, that is, from the code despreading processing section 8500, and passes them to a succeeding stage circuit. For example, data of 1.25 gigabits/second (Gbps) supplied thereto from the code despreading processing section 8500 are passed to a succeeding stage through the data interface section 8600.

### Operation of the Communication Apparatus

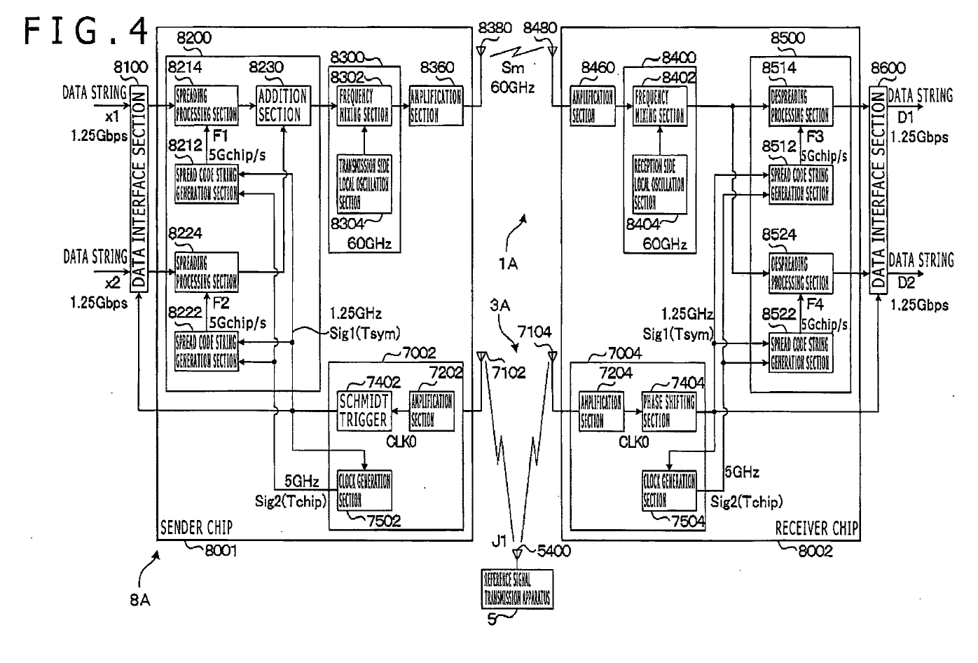

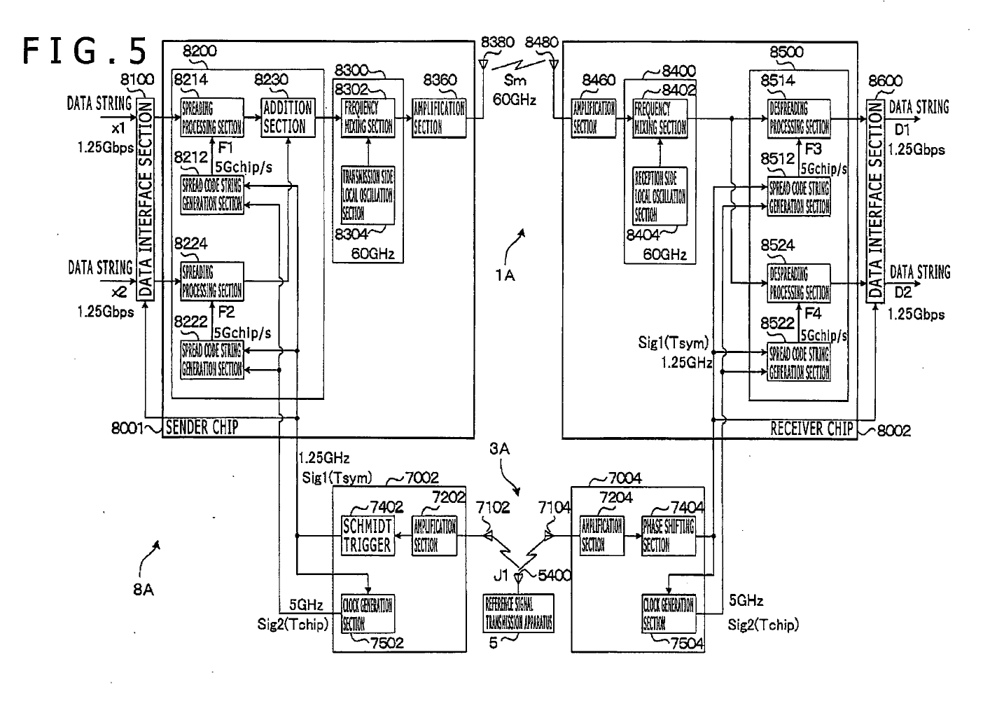

FIGS. 4 and 5 illustrate different examples of general operation of the communication apparatus 8A according to the working example 1. The first example illustrated in FIG. 4 represents a mode wherein both of the transmission side and the reception side include a communication chip 8000 which in turn includes a clock production section which utilizes the reference signal reception device 7. Meanwhile, the second example illustrated in FIG. 5 represents a different mode in which both of the transmission side and the reception side include, separately from the communication chip 8000, a clock production section which utilizes the reference signal reception device 7. Though not shown, a further mode in which one of the transmission side and the reception side includes, in the communication chip 8000, a clock production section which utilizes the reference signal reception device 7 while the other one of the transmission side and the reception side includes, separately from the communication chip 8000, a clock production section which utilizes the reference signal reception device 7. As the modulation method, the BPSK is adopted. Since the first and second examples are different only in whether or not the clock production section is built in the communication chip, description is given below of the first example wherein the clock production section is built in the communication chip 8000.

It is to be noted that, in the case of application to intra-apparatus or intra-housing signal transmission, the components such as the sender chip 8001 and the receiver chip 8002 are accommodated in the same housing, preferably together with the reference signal transmission device 5. Then, in the housing, a wireless signal transmission path which allows transmission by radio is formed between the code spreading processing section 8200 which is an example of the first signal processing section and the code despreading processing section 8500 which is an example of the second signal processing section.

Further, in the case of application to inter-apparatus signal transmission, the sender chip 8001 is accommodated in a housing of a first electronic instrument while the receiver chip 8002 is accommodated in a housing of a second electronic instrument. Preferably, the reference signal transmission device 5 is accommodated in the housing of one of the first and second electronic instrument. Further, when the first and second electronic instrument are disposed in position, a wireless signal transmission path which allows transmission by radio is formed between the code spreading processing section 8200 which is an example of the first signal processing section and the code despreading processing section 8500 which is an example of the second signal processing section.

### Radio Signal Transmission Path

The radio signal transmission line may be any transmission line if it can transmit a radio signal, which representatively is a millimeter wave signal, therethrough between the transmission and reception sides. For example, the radio signal transmission line may include an antenna structure or antenna coupling section or may not include an antenna structure to establish coupling. Although such a “radio signal transmission line” may be the air, that is, the free space, it preferably has a structure called millimeter wave confining structure which confines a millimeter wave signal in the transmission line to transmit the millimeter wave signal. By positively utilizing the millimeter wave confining structure, for example, layout of the millimeter wave signal transmission line can be settled arbitrarily like an electric wiring line. Although a wireless transmission line of the millimeter wave confining structure typically is, for example, a waveguide, it is not limited to this. For example, a wireless transmission line called dielectric transmission line or millimeter wave intra-dielectric transmission line formed from a dielectric material which can transmit a millimeter wave signal therethrough or a hollow waveguide which configures a transmission line and includes a shielding material which is provided so as to surround the transmission line and suppresses external radiation of the millimeter wave signal such that the inside of the shield material is hollow may be used. By providing flexibility to the dielectric material or the shield material, layout of the millimeter wave signal transmission line is facilitated. Incidentally, in the case where the “radio signal transmission line” is the air, that is, the free space, each signal coupling section assumes an antenna structure, by which a signal is transmitted in the space of a short distance. On the other hand, in the case where the “radio signal transmission line” is configured from a dielectric material, although it can assume an antenna structure, this is not essential.

### Transmission Side

In the sender chip 8001, that is, in the communication device 2 on the transmission side, the code spreading processing section 8200 includes a spread code string generation section 8212 and a spreading processing section 8214 corresponding to the data string x1, a spread code string generation section 8222 and a spreading processing section 8224 corresponding to the data string x2, and an addition section 8230. Further, the sender chip 8001 includes a clock production section 7002, which is an example of the first clock production section and utilizes the reference signal reception device 7. The clock production section 7002 includes an amplification section 7202 which corresponds to the amplification section 7200, a Schmidt trigger 7402 which corresponds to the reference signal reproduction section 7400, and a clock generation section 7502 which corresponds to the multiplication reference signal production section 7500.

The Schmidt trigger 7402 includes a function of a binarization section for acquiring a reference clock, that is, the symbol periodic signal Sig1, as binary data. In particular, the Schmidt trigger 7402 waveform shapes the reference signal CLK0, which is based on the reference signal J1, amplified by the amplification section 7202 to acquire the symbol periodic signal Sig1 of the symbol period Tsym and supplies the symbol periodic signal Sig1 to the data interface section 8100, spread code string generation section 8212 and spread code string generation section 8222.

The clock generation section 7502 generates a reference clock, that is, a spread code rate signal Sig2, of the period Tchip synchronized with the symbol periodic signal Sig1 supplied thereto from the Schmidt trigger 7402 and supplies the spread code rate signal Sig2 to the spreading processing section 8214 and the spreading processing section 8224. The symbol periodic signal Sig1 and the spread code rate signal Sig2 have a frequency relationship of Tsym=SF×Tchip. The symbol periodic signal Sig1 and the spread code rate signal Sig2 produced by the clock production section 7002 side are an example of the first reference clocks for the first signal process, that is, the code spreading process, regarding the radio communication process of the spectrum spreading method.

The data interface section 8100 outputs the data string x1 and the data string x2 in synchronism with the symbol periodic signal Sig1 to the code spreading processing section 8200.

The spread code string generation section 8212 outputs, based on the symbol periodic signal Sig1 and the spread code rate signal Sig2 supplied thereto from the clock production section 7002, a spread code F1 having a code string period equal to the clock period and a same code string period of the spreading processing section 8214. The spreading processing section 8214 multiplies the data string x1 supplied thereto in synchronism with the symbol periodic signal Sig1 through the data interface section 8100 by the spread code F1 supplied thereto from the spread code string generation section 8212 to carry out code spreading, and then supplies processed data to the addition section 8230. Similarly, the spread code string generation section 8222 outputs, based on the symbol periodic signal Sig1 and the spread code rate signal Sig2 supplied thereto from the clock production section 7002, a spread code F2 having a code string period equal to the clock period to the spreading processing section 8224. The spreading processing section 8224 multiplies the data string x2 supplied thereto in synchronism with the symbol periodic signal Sig1 through the data interface section 8100 by the spread code F2 supplied thereto from the spread code string generation section 8222 to carry out code spreading, and supplies processed data to the addition section 8230.

### Reception Side

In the receiver chip 8002, that is, in the communication device 2 of the reception side, the code despreading processing section 8500 includes a spread code string generation section 8512 and a despreading processing section 8514 corresponding to the first data string D1 to be demodulated, and a spread code string generation section 8522 and a despreading processing section 8524 corresponding to the second data string D2 to be reproduced. The receiver chip 8002 includes a clock production section 7004 which is an example of the second clock production section and utilizes the reference signal reception device 7. The clock production section 7004 includes an amplification section 7204 which corresponds to the amplification section 7200, a phase shifting section 7404 which functions as a phase correction circuit and corresponds to the reference signal reproduction section 7400, and a clock generation section 7504 which corresponds to the multiplication reference signal production section 7500.

The phase shifting section 7404 has a function of a binarization section for acquiring a reference clock, that is, the symbol periodic signal Sig1, as binary data and a function of phase correction section for correcting the phase of the acquired symbol periodic signal Sig1. In particular, the binarization section of the phase shifting section 7404 waveform shapes the reference signal CLK0 amplified by the amplification section 7204 to acquire the symbol periodic signal Sig1 of the symbol period Tsym and supplies the symbol periodic signal Sig1 to the spread code string generation section 8512, spread code string generation section 8522 and data interface section 8600. The phase correction section of the phase shifting section 7404 has a correction amount determined based on communication environment characteristics such as a propagation delay amount of a signal from the reference signal transmission device 5 to a transmitter, particularly the sender chip 8001, and a receiver, particularly the receiver chip 8002, and carries out phase correction based on the determined correction amount.

The clock generation section 7504 generates a reference clock, that is, a spread code rate signal Sig2, of a period Tchip synchronized with the symbol periodic signal Sig1 supplied from the phase shifting section 7404 and supplies the spread code rate signal Sig2 to the despreading processing section 8514 and the despreading processing section 8524. The periodic relationship between the symbol periodic signal Sig1 and the spread code rate signal Sig2 is Tsym=SF×Tchip. The symbol periodic signal Sig1 and the spread code rate signal Sig2 produced by the clock production section 7004 side are an example of the second reference clock for the second signal process, that is, for the code despreading process, regarding a radio communication process of the spectrum spreading method.

The spread code string generation section 8512 outputs, based on the symbol periodic signal Sig1 and the spread code rate signal Sig2 supplied thereto from the clock production section 7004, a spread code F3 having a code string period equal to the clock period to the despreading processing section 8514. The despreading processing section 8514 multiplies the baseband signal demodulated by the demodulation functioning section 8400 by the spread code F3 supplied thereto from the spread code string generation section 8512 to carry out code despreading and then supplies processed data to the data interface section 8600. Similarly, the spread code string generation section 8522 outputs, based on the symbol periodic signal Sig1 and the spread code rate signal Sig2 supplied thereto from the clock production section 7004, a spread code F4 having a code string period equal to the clock period to the despreading processing section 8524. The despreading processing section 8524 multiplies the baseband signal demodulated by the demodulation functioning section 8400 by the spread code F4 supplied thereto from the spread code string generation section 8522 to carry out code despreading and then supplies processed data to the data interface section 8600.

The data interface section 8600 outputs despreading processed data supplied thereto from the despreading processing section 8514 and the despreading processing section 8524 as a first data string D1 and a second data string D2 in synchronism with the symbol periodic signal Sig1.

### Spread Code String Generation Section

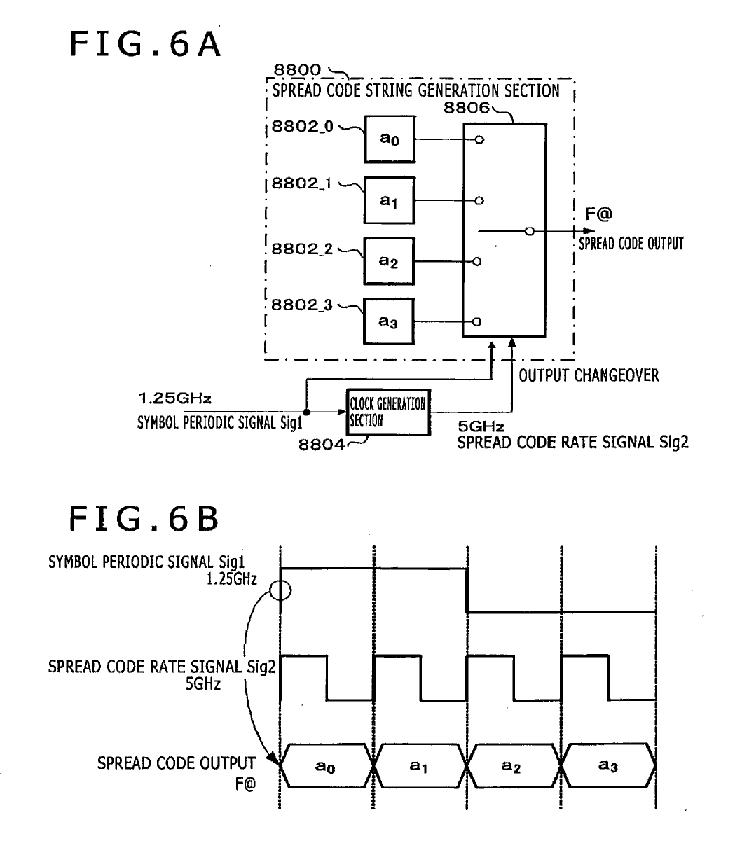

FIG. 6A shows the spread code string generation section 8212, spread code string generation section 8222, spread code string generation section 8512 and spread code string generation section 8522, which are collectively referred to as spread code string generation sections 8800. In particular, FIG. 6A shows an example of a configuration of the spread code string generation sections 8800, and FIG. 6B illustrates operation of the spread code string generation sections 8800.

Referring first to FIG. 6A, the spread code string generation sections 8800 include a plurality of registers 8802 in which values aᵢ of a spread code string a {a₀, a₁, a₂, . . . , a_{N-1}} are stored, and a selection section 8806 as a selector. The values aᵢ of the spread code string a {a₀, a₁, a₂, . . . , a_{N-1}} are inputted to individual input terminals of the selection section 8806. A clock generation section 8804 corresponds to the clock generation section 7502 or the clock generation section 7504 and has a multiplication section built therein which multiplies the frequency, for example, of a reference clock, here, of the symbol periodic signal Sig1, by a value determined in advance, here, by SF. The selection section 8806 has a first control input terminal to which the symbol periodic signal Sig1 is supplied as a reference clock and a second control input terminal to which the spread code rate signal Sig2 which is an output signal of the clock generation section 8804 as an output changeover signal.

Operation of the spread code string generation sections 8800 is described now with reference to FIG. 6B. In the example of operation illustrated, the clock generation section 8804 multiplies the symbol periodic signal Sig1 of 1.25 gigahertz [GHz] to four times to produce a spread code rate signal Sig2 of 5 gigahertz, and supplies the spread code rate signal Sig2 as an output changeover signal to the control input terminal of the clock generation section 8804. The selection section 8806 successively selects and outputs the values aᵢ of the spread code string a {a₀, a₁, a₂, . . . , a_{N-1}} from a register 8802 one by one based on the output changeover signal, that is, based on the spread code rate signal Sig2, from the clock generation section 8804 thereby to output a spread code F@ (@ is 1, 2, 3, 4) having a code string period equal to the clock period, that is, equal to the symbol period Tsym.

### Operation

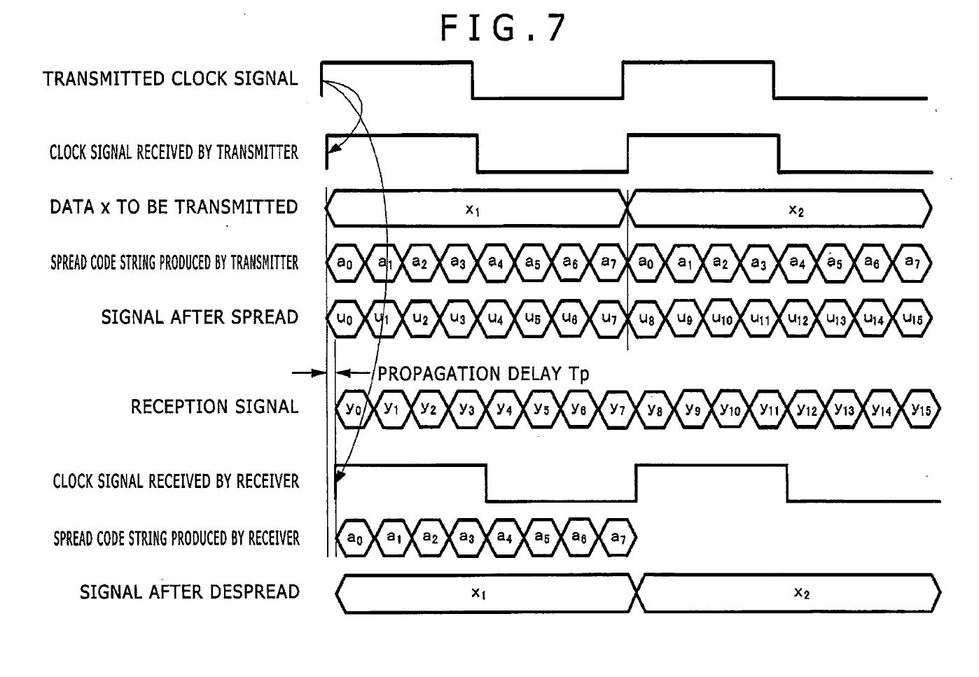

FIG. 7 illustrates general operation of the signal transmission apparatus 1A of the working example 1 described hereinabove with reference to FIGS. 4 and 5.

In the signal transmission apparatus 1A, the spread rate SF is SF=4, the chip rate is 5 giga chips/second (Gchips/s), and the modulation method is BPSK. Accordingly, the transmission rate of transmission object data is 1.25 gigabits/second. The reference signal transmission device 5 sends a reference signal CLK0, which corresponds to the reference signal J1, of 1.25 gigahertz equal to that of the symbol periodic signal Sig1.

The data interface section 8100, sender chip 8001, receiver chip 8002 and data interface section 8600 operate in synchronism with the reference signal CLK0 transmitted thereto from the reference signal transmission device 5, that is, in synchronism with the symbol periodic signal Sig1.

For example, on the transmission side, the reference signal CLK0 is received and amplified by the amplification section 7202, whereafter it is waveform shaped by the Schmidt trigger 7402 to obtain a symbol periodic signal Sig1 of the symbol period Tsym. Further, a spread code rate signal Sig2 of a period Tchip is generated in synchronism with the symbol periodic signal Sig1 by the clock generation section 7502. Also on the reception side, the reference clocks, that is, the symbol periodic signal Sig1 and the spread code rate signal Sig2, are received. The phases of the symbol periodic signal Sig1 and the spread code rate signal Sig2 can be adjusted by the phase shifting section 7404.

The data interface section 8100 outputs the data string x1 and the data string x2 in synchronism with the symbol periodic signal Sig1. The spreading processing section 8214 and the spreading processing section 8224 output the spread code F1 and the spread code F2 having a code string period equal to the clock period in synchronism with each other, respectively. The spreading processing section 8214 and the spreading processing section 8224 multiply the first data string D1 and the second data string D2 by the corresponding spread code F1 and the spread code F2 to spread the first data string D1 and the second data string D2, respectively. Thereafter, the modulation functioning section 8300 frequency converts the spread data strings into those of a predetermined frequency such as, for example, 60 gigahertz and signals resulting data.

The receiver chip 8002 receives a radio signal transmitted from the sender chip 8001, and the demodulation functioning section 8400 converts the received signal into a baseband signal, whereafter the despreading processing section 8514 or the despreading processing section 8524 of the code despreading processing section 8500 despreads the baseband signal. The timing of the spread code strings at this time depends upon the propagation delay of signals from the reference signal transmission device 5 to the sender chip 8001 and the receiver chip 8002, and this is corrected by the phase shifting section 7404.

For example, as a technique for implementing high speed signal transmission between electronic instruments disposed at a comparatively short distance such as, for example, within a range of 10 and several cm or within one electronic instrument, for example, LVDS (Low Voltage Differential Signaling) is known. However, as further increase of the amount of transmission data proceeds in recent years, increase in power consumption, increase of the influence of signal distortion by reflection and so forth, increase of unnecessary radiation (problem of EMI) and so forth make problems. For example, the LVDS is reaching its limit in the case where an image signal including a picked up image signal, a signal of a computer image or a like signal is transmitted at a high speed, that is, on the real time basis, within an apparatus or between different apparatus.

In order to cope with high speed transmission of data, the number of wiring lines may be increased to lower the transmission speed per one signal line by parallelization of signals. However, this countermeasure gives rise to increase of the number of input and output terminals. As a result, complication of a printed board or cable wiring, increase of the semiconductor chip size and so forth are involved. Further, since a large amount of data is propagated at a high speed by wiring lines, EM failure makes a problem.

The programs in the LVDS or the technique of increasing the wiring line number all arise from transmission of a signal by an electric wiring line. Therefore, as a technique for solving the problems arising from transmission of a signal by an electric wiring line, a technique of eliminating a wiring line and transmitting a signal by radio may be adopted. As a technique for eliminating an electric wiring line and transmitting a signal by radio, for example, signal transmission within a housing may be carried out by radio transmission while the UWB (Ultra Wide Band) communication method is applied (hereinafter referred to as first technique). Or a carrier frequency in the millimeter waveband having a short wavelength from 1 to 10 mm may be used (hereinafter referred to as second technique).

However, in the UWB communication method of the first technique, the carrier frequency is low, and therefore, the first technique is not suitable for such high speed communication as transmission of, for example, a video signal. Further, the first technique has a problem with regard to the size in that a large antenna is used. Further, since the frequency used for transmission is proximate to a frequency for other baseband signal processing, there is a problem also in that interference is likely to occur between the radio signal and the baseband signal. Further, where the carrier frequency is low, it is likely to be influenced by noise of a driving system in the apparatus, and a countermeasure is required. In contrast, as in the second technique if a carrier frequency in the millimeter waveband of a shorter wavelength or in the submillimeter waveband of a further shorter wavelength of 0.1 to 1 mm is used, then the problems of the antenna size and the interference can be solved.

When a radio signal is used to carry out signal transmission, a plurality of signals may be multiplexed and transmitted. As an example, for example, code division multiplexing of multiplying a data string by code strings orthogonal to each other to carry out addition and multiplexing and then transmitting the multiplexed signals is known. The code division multiplexing method is characterized in that a plurality of data strings can be multiplexed with a single carrier.

For example, by applying the code division multiplexing method to implement a wireless transmission apparatus using a millimeter wave, high speed data transmission can be implemented. Particularly where such an apparatus is applied to communication within an apparatus such as communication between chips, between boards or between modules, a transmission line by a conductor is unnecessary. Therefore, also enhancement in degree of freedom in arrangement of circuit boards, reduction in mounting cost, mitigation of EMI problems conspicuous with the LVDS and so forth can be reduced. Although a flexible board has a problem in reliability of a connector section, the reliability can be enhanced by application of wireless transmission.

Within an apparatus or between different apparatus, a plurality of signals having different transmission rates or different data widths are transmitted between communication circuits. As a method for multiplexing different signals, roughly four techniques including frequency division multiplexing, time division multiplexing, space division multiplexing and code division multiplexing are available. Here, a transmission apparatus within an apparatus or between different apparatus may use one or plural ones of the four techniques.

The frequency division multiplexing is a method of transmitting a plurality of data changing the carrier frequency and requires preparation of a plurality of transmitters and a plurality of receivers whose carrier frequencies are different from each other. The time division multiplexing is a method of transmitting a plurality of data changing the signaling timing and requires preparation of a mechanism for defining the signaling timings of the data for both of a transmitter and a receiver. The space division multiplexing is a method of transmitting a plurality of data through a plurality of transmission lines which can be isolated from each other and involves, for example, preparation of a plurality of transmission lines and use of the directivity of an antenna. The code division multiplexing is a method of multiplying a data string by code strings orthogonal to each other and adding and multiplexing resulting data and then transmitting the multiplexed data as described above. Although the code division multiplexing can multiplex data strings of different transmission rates, a synchronization mechanism for spread codes is required. Although a receiver of the spectrum spreading method in the past which does not adopt the working example 1 uses a matched filter or the like, the receiver is complicated and is disadvantageous in the power consumption and the circuit scale.

Meanwhile, the signal transmission apparatus 1A of the working example 1 is generally constructed by adding the reference signal transmission apparatus 3A which includes the reference signal transmission device 5 and the reference signal reception device 7 to the communication apparatus 8A configured from a transmitter and a receiver. A reference clock signaled from the reference signal transmission device 5 is supplied to the sender chip 8001 serving as a transmitter and is inputted to the spread code string generation section 8212 and the spread code string generation section 8222 of the code spreading processing section 8200. Also the reception side is similar, and a reference clock which makes a reference to the symbol periodic signal Sig1 and the spread code rate signal Sig2 signaled from the reference signal transmission device 5 is supplied to the receiver chip 8002 as a receiver and is inputted to the spread code string generation section 8512 and the spread code string generation section 8522 of the code despreading processing section 8500.

Consequently, spread codes handled by a transmitter and a receiver are synchronized with one period of the symbol periodic signal Sig1. Accordingly, the receiver does not require a timing detection circuit of a code for despreading such as a matched filter. In particular, since a reference clock which makes a reference to the symbol periodic signal Sig1 and the spread code rate signal Sig2 is sent from the reference signal transmission device 5 of the reference signal transmission apparatus 3 and received by a transmitter and a receiver to establish synchronism of spread code strings, the synchronization mechanism of the receiver is synchronized. Consequently, the power consumption and the circuit size can be suppressed. For example, since the code division multiplexing method can be used for transmission within an apparatus, an advantage that also a plurality of data strings having different data rates can be multiplexed can be achieved.

### Working Example 2

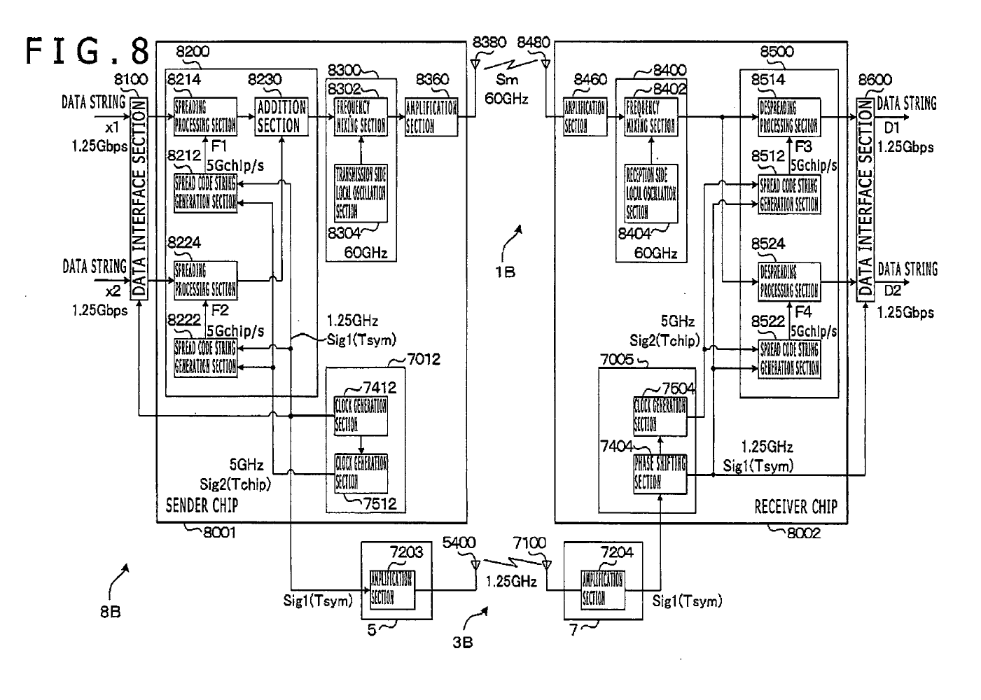

FIG. 8 shows a communication apparatus 8B according to a working example 2. In the following, principally differences of the working example 2 from the working example 1 are described simply.

The communication apparatus 8B of the working example 2 including a signal transmission apparatus 1B and a reference signal transmission apparatus 3B includes a reference signal transmission device 5 on the communication device 2 side of the transmission side or the reception side such that a signal produced by an oscillator, that is, by a reference oscillator, a local oscillator circuit or the like, used in the communication device 2 is utilized as a reference clock, which corresponds to the reference signal J1, to be signaled to the other communication device 2. The working example 2 is suitable where it is applied to a signal transmission apparatus which transmits a clock together with data which is a transmission object signal. In this instance, the reference signal transmission device 5 need not include a function particularly for producing the reference signal J1 but functions simply as a reference signal outputting section for outputting a reference signal. An apparatus simpler than that of the working example 1 can be implemented.

In FIG. 8, the apparatus as an example is shown in the form wherein a reference clock on the transmission side is transmitted as the reference signal J1. Incidentally, although FIG. 8 shows the reference signal transmission device 5 separately from the sender chip 8001, the reference signal transmission device 5 may otherwise be built in the sender chip 8001. Similarly, although the reference signal reception device 7 is shown separately from the receiver chip 8002, the reference signal reception device 7 may be built in the receiver chip 8002. If the reference signal transmission device 5 or the reference signal reception device 7 is built in a communication chip, that is, in the sender chip 8001 or the receiver chip 8002, then the general configuration of the communication apparatus 8B can be made compact. Description is given in contrast to the working example 1. The sender chip 8001, that is, the communication device 2 on the transmission side, includes a clock production section 7012 in place of the clock production section 7002. The clock production section 7012 includes a clock generation section 7412 for generating a symbol periodic signal Sig1 and a clock generation section 7512 for generating a spread code rate signal Sig2. The sender chip 8001 is equivalent to the configuration which omits the amplification section 7202 and the Schmidt trigger 7402 from the clock production section 7002 but includes the clock generation section 7412 instead. The reference signal transmission device 5 includes an amplification section 7203. The amplification section 7203 receives the symbol periodic signal Sig1 from the clock generation section 7412 as a synchronization clock and signals the received synchronization clock as it is. The receiver chip 8002, that is, the communication device 2 on the reception side, includes a clock production section 7005 in place of the clock production section 7004. The clock production section 7005 is equivalent to the configuration where the amplification section 7204 is omitted from the clock production section 7004. The reference signal reception device 7 includes the amplification section 7204 omitted from the clock production section 7004. In short, in the working example 2, the clock production section 7005 and the amplification section 7204 of the reference signal reception device 7 cooperatively configure an entire reference signal reception apparatus of a configuration same as that of the clock production section 7004.

In the working example 2 having such a configuration as described above, the transmission side uses a synchronization clock to synchronize spread code strings and signals the synchronizing clock from the reference signal transmission device 5 by radio. On the reception side, the synchronizing clock signaled from the reference signal transmission device 5 is received by the reference signal reception device 7 and passed to the phase shifting section 7404 of the receiver chip 8002. The receiver chip 8002 includes the demodulation functioning section 8400 and the code despreading processing section 8500 provided in the working example 1 and carries out a despreading process based on the synchronizing clock received by the reference signal reception device 7.

### Working Example 3

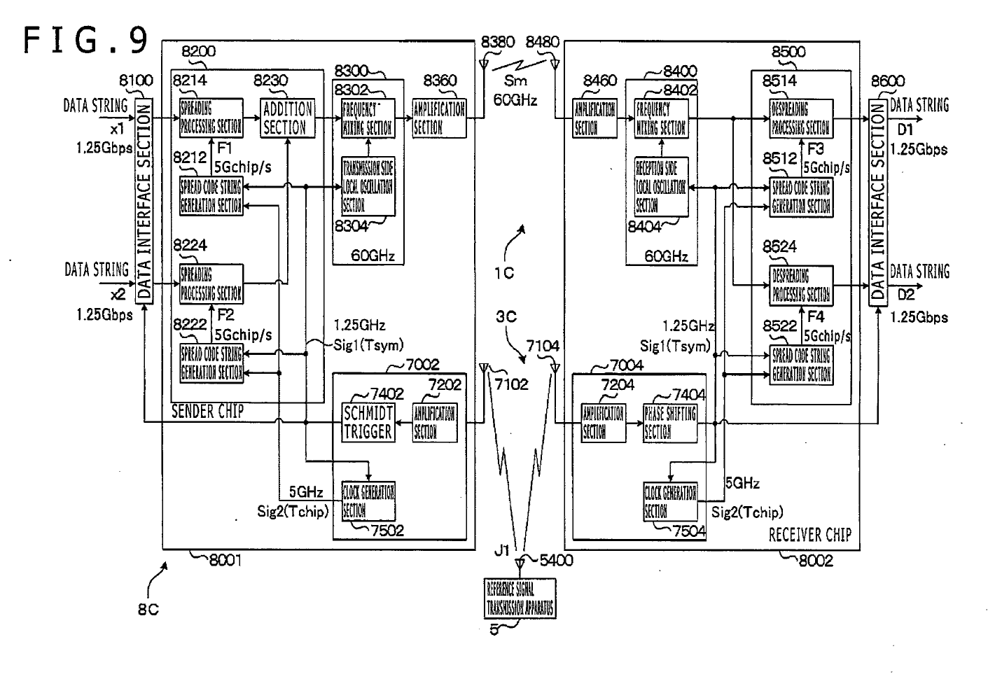

FIG. 9 shows a communication apparatus 8 according to a working example 3. In the following, description is given principally of differences of the working example 3 from the working example 1.

The communication apparatus 8C in the working example 3 including a signal transmission apparatus 10 and a reference signal transmission apparatus 3C is defined in that, on the basis of the working example 1, also a carrier signal produced by a local oscillation circuit, that is, by the transmission side local oscillation section 8304 or the reception side local oscillation section 8404, of at least one, that is, either one, preferably both, of the transmission side and the reception side, is synchronized with the reference signal J1 signaled from the reference signal transmission device 5. In other words, a method of synchronizing the local oscillator with the reference signal J1 signaled from the reference signal transmission device 5 is applied. Upon such synchronization process, preferably an injection locking method is applied.

While, in the description of the working example 1, timing synchronization with a chip rate of spread code strings is described, in the code division multiplexing method, it is preferable to establish also carrier frequency synchronism. While the working example 1 is described assuming that the reception side uses a popular technique to establish synchronism of a carrier signal, in the working example 3, a synchronization process is carried out based on the reference signal J1 signaled from the reference signal transmission device 5. This example is shown in a mode in which both of the communication devices 2 of the transmission side and the reception side synchronize the local oscillators with the reference signal J1 signaled from the reference signal transmission device 5. While a symbol periodic signal Sig1 is produced by the clock production section 7002, that is, by the Schmidt trigger 7402, on the transmission side and by the clock production section 7004, that is, by the phase shifting section 7404, on the reception side, based on the reference signal J1 signaled from the reference signal transmission device 5, the symbol periodic signal Sig1 is used as a reference clock for the local oscillation circuits having, for example, a PLL configuration or an injection locking configuration.

For example, as seen at a right lower portion of FIG. 9, a local oscillation circuit of a PLL configuration such as the transmission side local oscillation section 8304 or the reception side local oscillation section 8404 includes an M frequency dividing section, an N frequency dividing section, a phase comparison section (PD), a loop filter section (LPF), an oscillator section and so forth. The oscillation section may be any of, for example, a voltage-controlled oscillation circuit (VCO), and a current-controlled oscillation circuit (CCO).

In the local oscillation circuit, the symbol period Tsym is divided to 1/M by the M frequency dividing section and used as a reference for the phase comparator, and high frequency components of the comparison output are removed or suppressed by the loop filter section to produce a control signal for the oscillation section. While the oscillation output of the oscillator is used as a carried signal, it is divided to 1/N by the N frequency dividing section and used as a reference signal for the phase comparator. Consequently, the local oscillation circuit can produce a carrier signal synchronized with the symbol periodic signal Sig1. The carrier signal synchronized with the symbol periodic signal Sig1 can be used by a frequency conversion section such as the frequency mixing section 8302 or the reception side local oscillation section 8404. By carrying out such processing as described above on both of the transmission side and the reception side, frequency synchronism of carrier signals between transmission and reception can be established with certainty.

Though not shown, various configurations for a local oscillator which applies the injection locking method are known, and any of them may be adopted. Detailed description of the same is omitted herein. If the injection locking method is applied to the local oscillator, then a carrier signal for demodulation synchronized with a carrier signal for modulation can be produced with certainty by a simpler and easier configuration than a PLL configuration. If the injection locking is applied, then since a carrier signal for modulation used for modulation, that is, for up conversion, and a carrier signal for demodulation used for demodulation or down conversion can be placed into a synchronized state with each other with certainty, even if the stability of the frequency of the carrier signal for modulation is moderated to carry out wireless transmission, the transmission object signal can be demodulated appropriately. In addition, in the demodulation, application of synchronous detection is easy, and by developing and using synchronous detection for orthogonal detection, not only amplitude detection but also phase modulation or frequency modulation can be applied. This signifies that the data transmission rate can be raised, for example, by orthogonalizing a modulation signal or the like.

When radio signal transmission is carried out within an apparatus or housing or between different apparatus, even if the stability of the frequency of a carrier signal for modulation is moderated, the transmission object signal can be demodulated appropriately on the reception side. Since the stability of the frequency of the carrier signal may be moderated, an oscillation circuit which is simple and easy in circuit configuration can be used for the local oscillation circuit. Also the general apparatus configuration can be made simple and easy. Since the stability of the frequency of the carrier signal may be moderated, the entire oscillation circuit including a tank circuit and also the frequency conversion section can be formed on the same semiconductor substrate. Therefore, it is easy to implement a one-chip oscillation circuit or semiconductor integrated circuit including a built-in tank circuit or a one-chip communication circuit or semiconductor integrated circuit which includes a built-in tank circuit.

By transmitting the reference signal J1, which makes a reference to a reference clock to be used for transmission and reception separately from the radio signal Sm for a transmission object signal such that the local oscillation signal or carrier signal and a spread code string are synchronized with each other based on the reference signal J1, the synchronization mechanism on the reception side can be simplified and the power consumption and the circuit size can be suppressed. By using injection locking for synchronization of the local oscillation circuit or the reference signal reception device 7, that is, the clock production section 7002 or the clock production section 7004, with the reference signal J1, the circuit configuration can further simplified. Since the code division multiplexing method can be used for wireless transmission within an apparatus or between different apparatus at a comparatively short distance, also a plurality of data strings having different data rates can be multiplexed.

<Contrast with a Comparative Example>

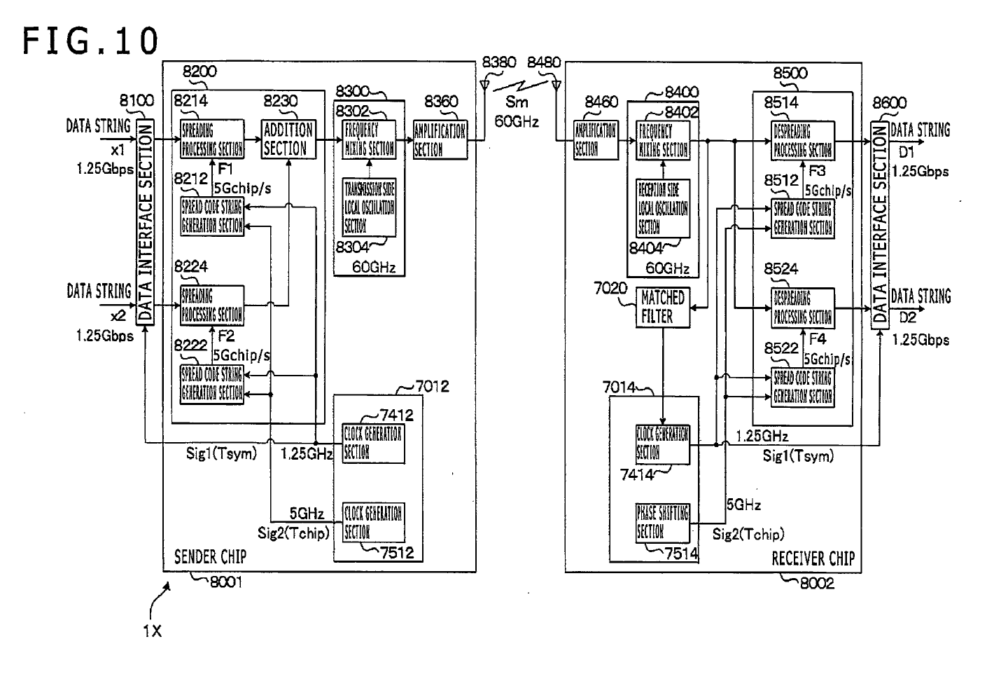

FIG. 10 shows a signal transmission apparatus 1X of a comparative example with the working examples 1 to 3. Particularly, FIG. 10 shows the signal transmission apparatus 1X in contrast with the working example 1. In FIG. 10, framing and channel coding which essentially have no relationship are omitted in comparison.

The comparative example is different from the working example 1 in that the signal transmission apparatus 1X does not include the reference signal transmission apparatus 3 but includes, on the transmission side, the clock production section 7012 and, on the reception side, a clock production section 7014 in place of the reference signal reception device 7, that is, in place of the clock production section 7002 and the clock production section 7004, and further includes, on the reception side, a matched filter 7020.

The clock production section 7012 includes a clock generation section 7412 for generating a symbol periodic signal Sig1 and a clock generation section 7512 for generating a spread code rate signal Sig2. The clock production section 7014 includes a clock generation section 7414 for generating the symbol periodic signal Sig1 and a clock generation section 7514 for generating a spread code rate signal Sig2. The matched filter 7020 is supplied with a reception signal or baseband signal demodulated by the demodulation functioning section 8400, and an output signal of the matched filter 7020 is supplied to the clock generation section 7414.

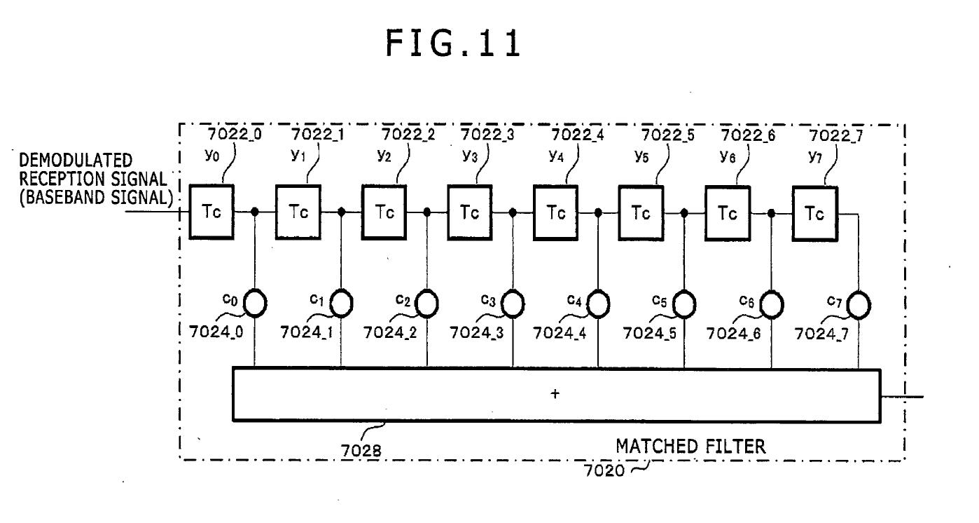

FIG. 11 shows an example of a configuration of the matched filter 7020. The matched filter 7020 includes a cascade connection of a plurality of delay elements 7022 or registers, a tap coefficient section 7024 provided for each of the delay elements 7022, and an addition section 7028, and has a FIR (Finite Impulse Response) filter configuration.

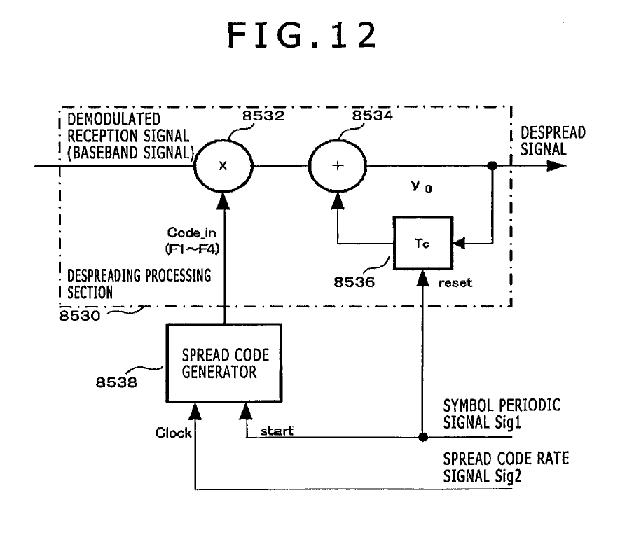

FIG. 12 shows an example of a configuration of the despreading processing section 8514 and the despreading processing section 8524, which are collectively referred to as despreading processing section 8530. The despreading processing section 8530 includes a multiplication section 8532, an addition section 8534, and a register 8536. A spread code generator 8538 shown in FIG. 12 corresponds to the spread code string generation section 8212, spread code string generation section 8222, spread code string generation section 8512 and spread code string generation section 8522.

The despreading processing section 8530 receives a reception signal and spread codes F1 to F4 (code_in) having a code string period equal to the clock period outputted from the spread code generator 8538 and outputs a despread signal. More particularly, the reception signal is inputted to the multiplication section 8532, and the symbol periodic signal Sig1 is inputted to the register 8536 and the spread code generator 8538 while the spread code rate signal Sig2 is inputted to the spread code generator 8538, and a despread signal is outputted from the addition section 8534.

The multiplication section 8532 multiplies the reception signal from the demodulation functioning section 8400 by the spread codes F1 to F4 (code_in) which are output signals of the spread code generator 8538, and a result of the multiplication is supplied to the addition section 8534. The addition section 8534 adds the result of the multiplication and a return signal from the register 8536 and outputs the sum as a despread signal. At this time, after the process is carried out by a number of times equal to the number of samples corresponding to the spread code length, the despreading processing section 8530 outputs the despread signal from the addition section 8534. Then, in synchronism with the symbol periodic signal Sig1, the register 8536 is reset to zero.

### Operation

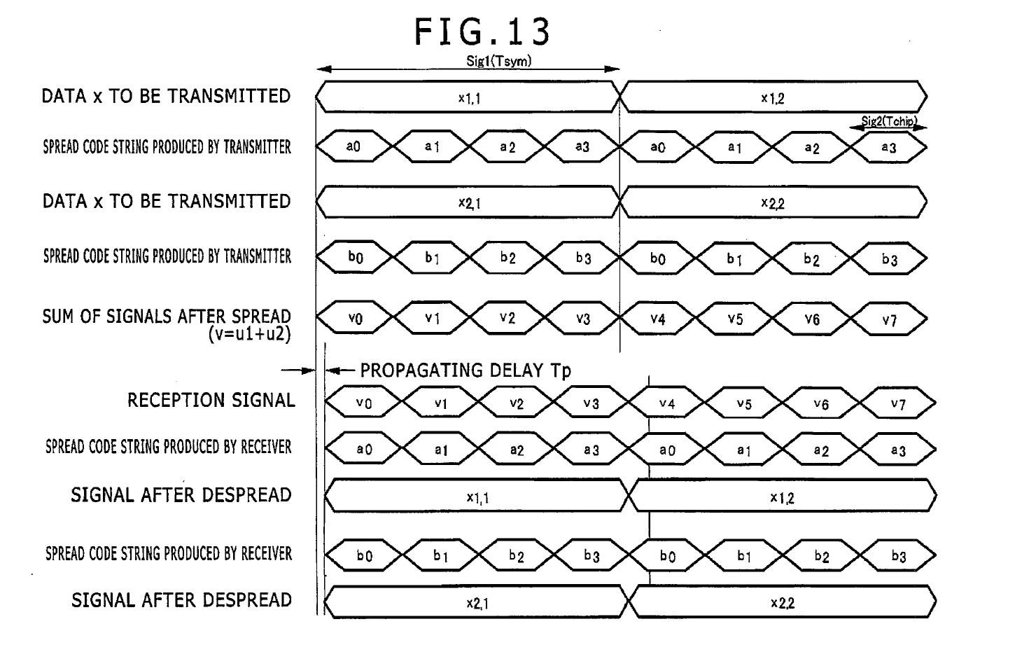

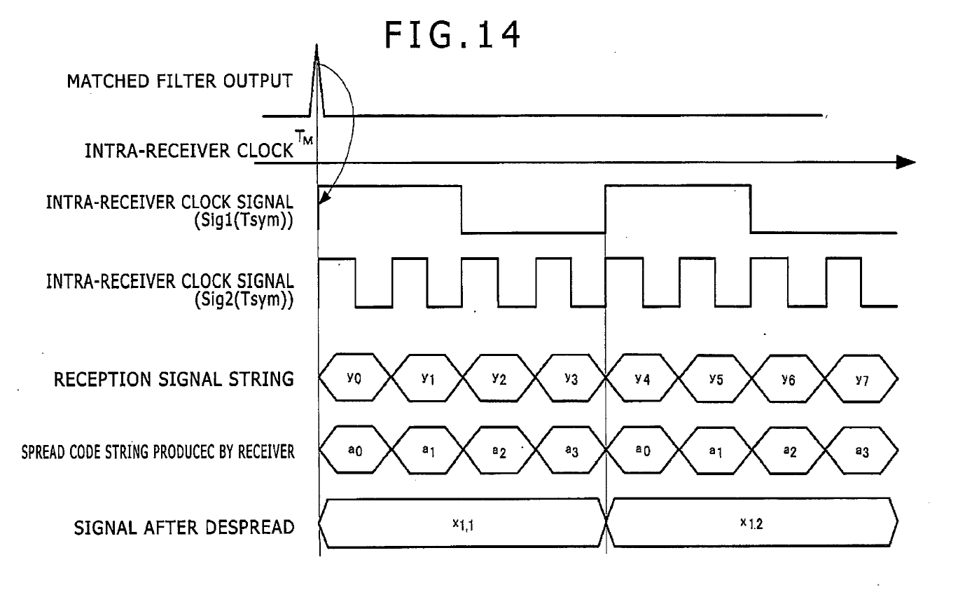

FIG. 13 illustrates spreading and despreading, and FIG. 14 illustrates reception timing detection by a matched filter.

The code division multiplexing is considered to be also as a method of superposing a plurality of data on the same carrier frequency using a statistical correlation characteristic or linear independency of a certain spread code string. In particular, a desired signal and any other signal are separated from each other using the fact that the inner product of certain code strings a {a₀, a₁, a₂, . . . , a_{N-1}} and a′ {a′₀, a′₁, a′₂, . . . , a′_{N-1}} assumes a value represented by the following expression (1) and that A²>>σ².

$$v = ( a , {a}^{′} ) = {\sum }_{i = 0}^{N - 1} {a}_{i} {{a}_{i}^{′}}^{*} = \{ \begin{matrix}{A}^{2} … a = {a}^{′} \\ {σ}^{2} … a \neq {a}^{′}\end{matrix} \} \qquad ( 1 )$$

This example of the code is a Walsh function which is an orthogonal code or a Gold string depending upon a false random string. In orthogonal codes, a finite number of strings are produced from a code length, and the inner product has a value only when the strings are same, but when the strings are different, the product is “σ²=0.” Taking the code length N=4 as an example, {1, 1, 1, 1}, {1, 1, −1, −1}, (1, −1, 1, −1) and {1, −1, −1, 1}. The pseudo random series is a string of a finite length obtained from a generation polynomial and has a sharp autocorrelation characteristic.

Here, the transmitter multiplies the transmission object data xⱼ by the spread code string (refer to FIG. 13). A result of the multiplication is represented by the following expression (2):

$$\begin{matrix}{u}_{1} = {ax}_{1} = \{ {a}_{0} {x}_{1} , {a}_{1} {x}_{1} , {a}_{2} {x}_{1} , … {a}_{N - 1} {x}_{1} \} \\ {u}_{2} = {bx}_{2} = \{ {b}_{0} {x}_{2} , {b}_{1} {x}_{2} , {b}_{2} {x}_{2} , … {b}_{N - 1} {x}_{2} \}\end{matrix} \} \qquad ( 2 )$$

In the transmitter, signals after spreading, signals u₁ and u₂ here, are added by the addition section 8230 to obtain a signal v. The signal v is multiplied by an output signal of the transmission side local oscillation section 8304 by the frequency mixing section 8302 of the modulation functioning section 8300 to convert the frequency thereof and is then amplified by the amplification section 8360, whereafter it is signaled from the transmission antenna 8380. This signal is received by a reception antenna 8480 after delayed by propagation delay Tp and is then amplified by an amplification section 8460, whereafter it undergoes frequency conversion into a baseband signal by the demodulation functioning section 8400.

Further, in the receiver, a prepared spread code string a₁ is used to carry out despreading for each N samples of the reception signal string. N corresponds to the spread rate SF.

If it is assumed that the timings of the reception signal y and the spread code string a of the receiver are in synchronism with each other as seen in FIG. 13, then the condition a=a′ of the expression (1) is satisfied and the first data string x₁ can be acquired. Similarly, the second data string x₂ can be acquired by using a spread code string a₂ to carry out despreading.

Here, in the code multiplexing method of the comparative example, a timing detection function of a spread code string is required. This is because the transmitter and the receiver operate with respective clocks independent of each other and besides the propagation delay is unknown. Generally, in a UMTS (Universal Mobile Telecommunications System) method, such a matched filter 7020 as shown in FIG. 11 is provided. The spread code strings in use are known, and the spread code string is tap coefficients of the matched filter 7020 which is a FIR filter.

Only when the reception signal y inputted to the matched filter 7020 exhibits such a timing as illustrated in FIG. 14, a high output as seen in FIG. 14 is obtained in accordance with the expression (1). By recording this timing as time T_{M} on the clock in the receiver, the receiver can know the timing of the spread code string according to the reception signal based on the time T_{M}. In the following, this timing is referred to as spread code timing T_{M}.

Since, in the cellular system, a mobile phone is always moving, it is necessary to always carry out path detection by means of the matched filter. In other words, signals of different arriving paths by scattering or reflection are received at different timings by the receiver. Therefore, pulses according the reception powers of the arriving paths and the delay time values appear on the matched filter output.

The despreading circuit, that is, the despreading processing section 8514 or the despreading processing section 8524, is normally called finger (refer to FIG. 12). The despreading circuit prepares a spread code string in accordance with the recorded spread code timing T_{M} described hereinabove and calculates the inner product with the reception signal to carry out despreading. Then, after processing for the sample number (N) corresponding to the spread code length, a result of the despreading is outputted and the register, that is, the register 8536 shown in FIG. 12, is reset to zero.

In the description of the working examples 1 to 3 and the comparative example, an AD converter and a DA converter are not described. This is because, in the description of the working examples 1 to 3 and the comparative example, they have no relationship to the essence of the disclosed technology. In an ordinary cellular apparatus, since a spreading process and a despreading process are executed in a digital region, an AD converter and a DA converter are provided. However, this is similar also to the working examples 1 to 3. Naturally, the spreading process and the despreading process are not limited to processing in the digital region, but may be carried out in an analog region (refer to, for example, Reference Document 2 to Reference Document 4 given below. In this instance, such an AD converter and a DA converter are not required.
Reference Document 2: U.S. Pat. No. 7,606,338
Reference Document 3: Japanese Patent No. 3377451
Reference Document 4: U.S. Pat. No. 4,475,208

Meanwhile, the inter-apparatus wireless transmission circuit replaces wiring lines between LSIs or substrates with wireless transmission (refer to, for example, Reference Document 5 given below).
Reference Document 5: Kawasaki et al., “A Millimeter-Wave Intra-Connect Solution,” IEEE ISSCC Dig. Tech. Papers, pp. 414-415, February 2010

In the case where such a technique as disclosed in Reference Document 5 is adopted, since such reduction in size and power consumption as to replace wiring lines is involved, it is difficult from the requirement described to apply the implementation method of a code spreading wireless transmission apparatus in the past as it is. Particularly a digital matched filter, which corresponds to the matched filter 7020, has difficulty in that the circuit scale and the power consumption increase. Further, since the intra-apparatus wireless transmission apparatus is different in use condition from a cellular apparatus, the circuit configuration requires re-consideration for this application. The “wireless transmission within an apparatus or between different apparatus” has such characteristics as described hereinabove. For example, while, in the case of the intra-apparatus wireless transmission, the necessity to use a pseudo random string for a spread code is low, in the case of the cellular system, since multi-paths are detected using a sharp autocorrelation characteristic of the string, a matched filter is used.

As radio communication methods, those disclosed in Reference Document 6 and Reference Document 7 given below are available in addition to those of Reference Document 2 to Reference Document 5.
Reference Document 6: Japanese Patent No. 3564480
Reference Document 7: Japanese Patent Laid-Open No. Hei 6-85799

According to the technique disclosed in Reference Document 6, a radio communication method is configured such that a signal of a frequency equal to that of a local oscillation circuit is sent separately and each of transmitters and receivers receives the signal such that the signal is injected into each local oscillation circuit to establish synchronism. Therefore, the technique can be regarded as a “carrier separate transmission method.” A transmission carrier signal and a reception carrier signal are produced based on a common reference signal, and in this regard, the radio communication method is similar to the configuration of the present embodiment wherein a common reference signal is used for transmission and reception. Thus, synchronism between carrier signals for transmission and reception can be established in regard to both of the frequency and the phase. However, the technique disclosed in Reference Document 6 requires wiring lines for making a reference signal common, and if the level of the reference signal becomes high, then a problem of unnecessary radiation occurs. Further, the technique of Reference Document 6 is specialized to synchronization of carriers but is silent of synchronization of spread code strings in code multiplexing radio communication.

According to the technique disclosed in Reference Document 7, synchronism between a transmission earth station and a reception earth station in satellite communication is established utilizing a terrestrial ISDN master clock. Therefore, the technique is considered to be a “carrier separate transmission method.” However, according to the technique disclosed in Reference Document 7, a reference clock is transmitted by wire transmission, but synchronization of spread code strings is not taken into consideration. Further, Reference Document 7 is silent of synthesis of spread code strings in spread code radio communication similarly to Reference Document 6.

### Present Working Example

According to the technique of the present working example, a reference signal J1 which makes a reference to a reference clock for a code division multiplexing process is set separately from a radio signal Sm for a transmission object signal, and a reference signal for a code division multiplexing process, in the preceding examples, the symbol periodic signal Sig1 and the spread code rate signal Sig2, is produced synchronously based on the reference signal J1. Therefore, a synchronization mechanism for establishing timing synchronism with the chip rate of spread code strings can be simplified, and the power consumption and the circuit size can be suppressed.

### Working Example 4

The working example 4 is an application to an electronic instrument. In the following, three representative examples are described.

### <Examples of Application to an Electronic Instrument>

### First Example

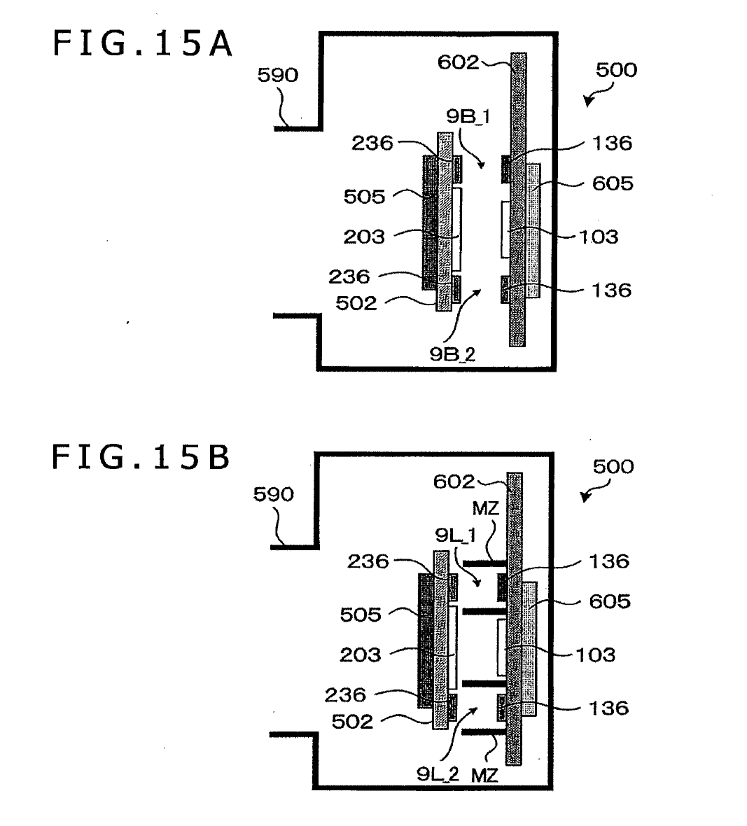

FIGS. 15A and 15B show a first example of the electronic instrument of the working example 4. The first example is an application to an image pickup apparatus as an electronic instrument which incorporates a solid-state image pickup apparatus. An image pickup apparatus of the type described is distributed, for example, as a digital camera, a video camera (camcorder) or a camera of a computer apparatus, that is, a Web camera, on the market.

The first example of the electronic instrument has a system configuration wherein a first communication device which corresponds to the communication device 2 is mounted on a main substrate on which a control circuit, an image processing circuit and so forth are mounted, and a second communication device, which corresponds to the communication device 2, is mounted on an image pickup substrate or camera substrate on which a solid-state image pickup apparatus is mounted. In the following description, it is assumed that the reference signal J1 is transmitted by wireless transmission in the millimeter band and data is transmitted by wireless transmission in the millimeter band.

Referring to FIGS. 15A and 15B, in a housing 590 of the image pickup apparatus 500, an image pickup substrate 502 and a main substrate 602 are disposed. A solid-state image pickup device 505 is mounted on the image pickup substrate 502. For example, the solid-state image pickup device 505 may include a CCD (Charged Coupled Device) sensor mounted on the image pickup substrate 502 together with a driving section such as a horizontal driver and a vertical driver or may be a CMOS (Complementary Metal-Oxide Semiconductor) sensor.

A semiconductor chip 103 which functions as the first communication device is mounted on the main substrate 602, and a semiconductor chip 203 which functions as the second communication device is mounted on the image pickup substrate 502. Though not shown, peripheral circuits such as an image driving section are mounted on the image pickup substrate 502 in addition to the solid-state image pickup device 505, and an image processing engine, an operation section, various sensors and so forth are mounted on the main substrate 602.

Each of the semiconductor chip 103 and the semiconductor chip 203 incorporates a function of the reference signal transmission device 5 and also a function of the reference signal reception device 7. Further, each of the semiconductor chip 103 and the semiconductor chip 203 incorporates functions equivalent to those of the sender chip 8001 and the receiver chip 8002. By incorporating the functions of the sender chip 8001 and the receiver chip 8002, each of the semiconductor chip 103, and the semiconductor chip 203 can cope also with bidirectional communication. These points apply similarly also to the other application examples hereinafter described.

The solid-state image pickup device 505 and the image pickup driving section correspond to application functioning sections of the LSI functioning section on the first communication apparatus side. The signal production section on the transmission side is connected to the LSI functioning section and is further connected to an antenna 236 through a transmission line coupling section. The signal production section and the transmission line coupling section are accommodated in the semiconductor chip 203 separate from the solid-state image pickup device 505 and are mounted on the image pickup substrate 502.

The image processing engine, operation section, various sensors and so forth correspond to the application functioning sections of the LSI functioning section of the second communication apparatus side, and the image processing section for processing a picked up image signal obtained by the solid-state image pickup device 505 is accommodated. The signal production section of the reception side is connected to the LSI functioning section, and is further connected to an antenna 136 through a transmission line coupling section. The signal production section and the transmission line coupling section are accommodated in the semiconductor chip 103 separate from the image processing engine and are mounted on the main substrate 602.

The signal production section on the transmission side includes, for example, a multiplexing processing section, a parallel to serial conversion section, a modulation section, a frequency conversion section, an amplification section and so forth. Meanwhile, the signal production section on the reception side includes, for example, an amplification section, a frequency conversion section, a demodulation section, a serial to parallel conversion section, a unification section and so forth. Those points are similar also to the other application examples hereinafter described.

An image signal acquired by the solid-state image pickup device 505 by radio communication carried out between the antenna 136 and the antenna 236 is transmitted to the main substrate 602 through a wireless signal transmission line 9 between the antennae. A configuration for allowing bidirectional communication may be applied. In this instance, for example, a reference clock and various control signals for controlling the solid-state image pickup device 505 are transmitted to the image pickup substrate 502 through the wireless signal transmission line 9 between the antennae.

In both of FIGS. 15A and 15B, two millimeter wave signal transmission lines 9 are provided. In FIG. 15A, the millimeter wave signal transmission lines 9 are formed as free space transmission lines 9B while, in FIG. 15B, the millimeter wave signal transmission lines 9 are formed as hollow waveguides 9L. The hollow waveguides 9L must be structured only such that they are covered with a shielding member therethrough and are hollow. For example, each of the hollow waveguides 9L is structured such that it is surrounded by a conductor MZ which is an example of the shielding member and is hollow. For example, the enclosure of the conductor MZ is attached to the main substrate 602 in such a form that it surrounds the antenna 136. The center of movement of the antenna 236 on the image pickup substrate 502 is disposed at a position opposing to the antenna 136. Since the conductor MZ is hollow, there is no necessity to use a dielectric material, and consequently, the wireless signal transmission line 9 can be configured simply and readily at a low cost. Here, for example, on the semiconductor chip 103 or the semiconductor chip 203, a processing circuit for transmission of a reference signal and a processing circuit for code division multiplexing transmission which utilizes a reference signal are mounted. Here, it is assumed that a processing circuit for transmission of a reference signal and a processing circuit for code division multiplexing transmission utilizing a reference signal are mounted on both of the semiconductor chip 103 and the semiconductor chip 203. Then, one of the two millimeter wave signal transmission lines 9 is used for code division multiplexing transmission while the other is used for transmission of a reference signal. To the code division multiplexing transmission which utilizes a reference signal, any of the working examples described hereinabove may be applied. Similarly to the second example described below, one wireless signal transmission line 9 may be provided and used commonly for code division multiplexing transmission and transmission of a reference signal.

### Second Example

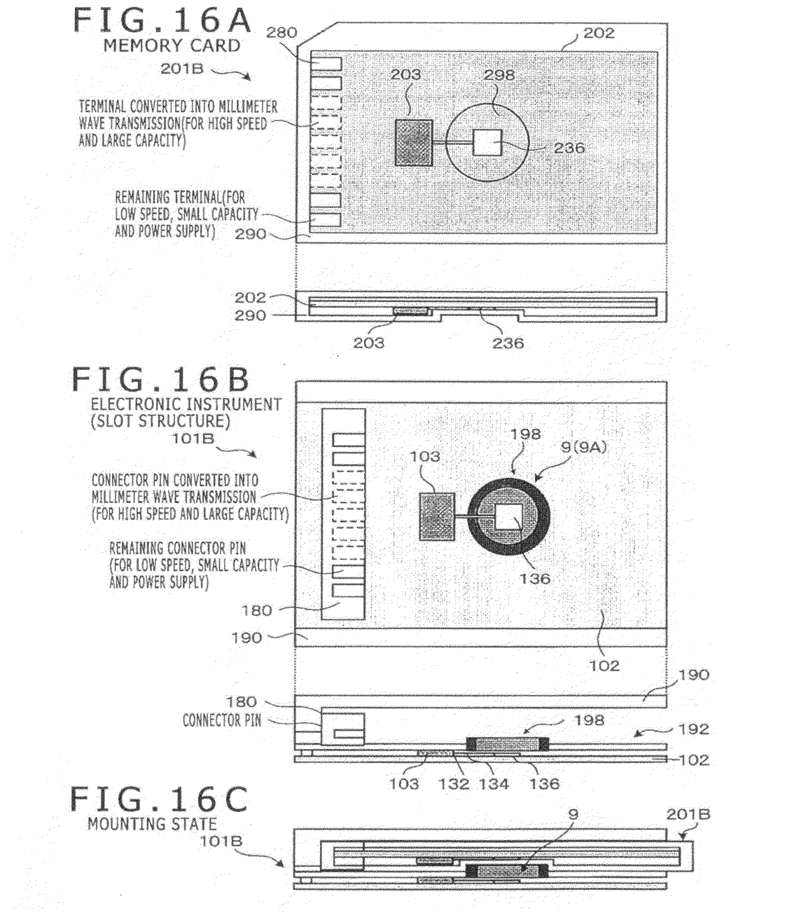

FIGS. 16A to 16C show a second example of the electronic instrument of the working example 4. The second example is an application in the case where, in a state in which a plurality of electronic instrument are integrated, signal transmission is carried out by wireless transmission between the electronic instruments. The second example particularly is an application to signal transmission between two electronic instruments when one of them is mounted on the other of them.

For example, an electronic instrument on the main body side is available which allows a card type information processing apparatus represented by an IC card or a memory card having a central processing unit (CPU), a nonvolatile storage device such as, for example, a flash memory and so forth built therein to be removably mounted thereon. An information processing apparatus of the card type which is an example of one or a first electronic instrument is hereinafter referred to as “card type apparatus” while the other or a second electronic instrument on the main body side is hereinafter referred to merely as electronic instrument.

An example of a structure of the memory card 201B is shown in plan and in section in FIG. 16A. An example of a structure of the electronic instrument 101B is shown in plan and in section in FIG. 16B. An example of a structure when the memory card 201B is inserted into a slot structure 4, particularly into an opening 192, of the electronic instrument 101B is shown in section in FIG. 16C.

The slot structure 4 is configured such that the memory card 201B, that is, a housing 290 of the memory card 201B, can be inserted through the opening 192 into and secured to a housing 190 of the electronic instrument 101B. A connector 180 on the receiving side is provided at a contacting position of the slot structure 4 with terminals of the memory card 201B. Signals to which wireless transmission is applied do not require connector terminals or connector pins.

A cylindrical concave configuration 298 in the form of a depression is provided on the housing 290 of the memory card 201B as shown in FIG. 16A while a cylindrical convex configuration 198 in the form of a protrusion is provided on the housing 190 of the electronic instrument 101B as shown in FIG. 16B. The memory card 201B has the semiconductor chip 203 on one face of a substrate 202, and the antenna 236 is formed on the one face of the substrate 202. The housing 290 has the concave configuration 298 formed on the face of the substrate 202 on which the antenna 236 is formed, and the concave configuration 298 is formed from a dielectric material which can transmit a radio signal.

On one side of the substrate 202, the connector 280 for connection to the electronic instrument 101B at a predetermined location of the housing 290 is provided at a predetermined position. The memory card 201B has a known terminal structure provided at part thereof for a low-speed small-amount signal or for power supply. Terminals are removed as indicated by broken lines in FIGS. 16A and 16B for which corresponding signals are transmitted by signal transmission by a millimeter wave.

As shown in FIG. 16B, the electronic instrument 101B has the semiconductor chip 103 on a face of a substrate 102 on the opening 192 side, and the antenna 136 is formed on one of faces of the substrate 102. The housing 190 has the opening 192 as the slot structure 4 into which the memory card 201B is removably inserted. At a portion of the housing 190 which corresponds to the concave configuration 298 when the memory card 201B is inserted in the opening 192, the convex configuration 198 having a millimeter wave confining structure or waveguide structure is formed such that it serves as a dielectric transmission line 9A.

As shown in FIG. 16C, the housing 190 of the slot structure 4 has such a mechanical structure that, when the memory card 201B is inserted through the opening 192, the convex configuration 198 or dielectric transmission line 9A and the concave configuration 298 contact in a complementary state with each other. When the concave and convex structures fit with each other, the antenna 136 and the antenna 236 are opposed to each other, and the dielectric transmission line 9A as the wireless signal transmission line 9 is disposed between them. Although the memory card 201B is sandwiched between the dielectric transmission line 9A and the antenna 236, since the concave configuration 298 is made of a dielectric material, this does not have a significant influence on wireless transmission in the millimeter waveband.

Here, for example, in the semiconductor chip 103 and/or the semiconductor chip 203, a processing circuit for transmission of a reference signal and a processing circuit for code division multiplexing transmission utilizing a reference signal are mounted. Further, one millimeter wave signal transmission line 9 is used for code division multiplexing transmission and used also for transmission of a reference signal. For the code division multiplexing transmission utilizing a reference signal, any of the working examples described hereinabove may be applied. Similarly as in the first example described hereinabove with reference to FIGS. 15A and 15B, two millimeter wave signal transmission lines 9 may be provided such that they are used separately for code division multiplexing transmission and for transmission of a reference signal.

### Third Example

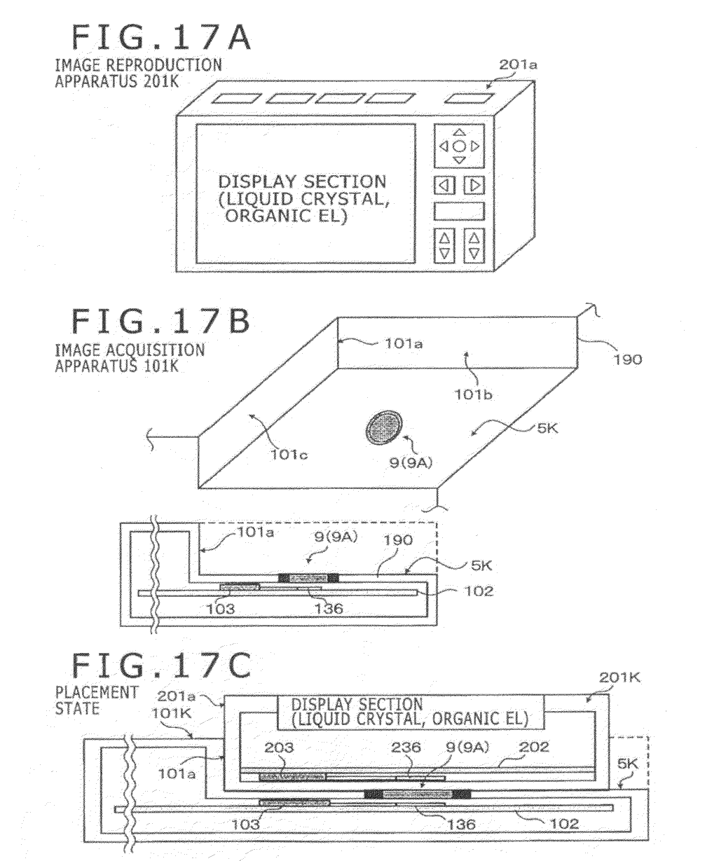

FIGS. 17A to 17C show a third example of the electronic instrument of the working example 4. Referring to FIGS. 17A to 17C, a signal transmission apparatus 1 includes an image reproduction apparatus 201K of the portable type as an example of the first electronic instrument and an image acquisition apparatus 101K as an example of the second or main body side electronic instrument in which the image reproduction apparatus 201K is incorporated. The image acquisition apparatus 101K has a receiving table 5K provided at a portion of the housing 190 thereof on which the image reproduction apparatus 201K is placed. It is to be noted that the receiving table 5K may be replaced by the slot structure 4 as in the second example. Between the two electronic instruments when one of the electronic instruments is mounted on the other one of the electronic instrument, signal transmission is carried out by radio similarly as in the second example. In the following, attention is paid particularly to differences of the third example from the second example.

The image acquisition apparatus 101K generally has a parallelepiped or box shape and cannot be regarded as that of a card type any more. The image acquisition apparatus 101K may be any apparatus only if it acquires, for example, dynamic picture data and may be, for example, a digital recording and reproduction apparatus or a ground wave television receiver. The image reproduction apparatus 201K includes, as application functioning sections, a storage apparatus for storing dynamic picture data transmitted thereto from the image acquisition apparatus 101K side, and a functioning section for reading out dynamic picture data from the storage apparatus and reproducing a dynamic picture on a display section such as, for example, a liquid crystal apparatus or an organic EL display apparatus. Structurally, it may be considered that the memory card 201B is replaced by the image reproduction apparatus 201K and the electronic instrument 101B is replaced by the image acquisition apparatus 101K.

In the housing 190 at a lower portion of the receiving table 5K, a semiconductor chip 103 is accommodated, for example, similarly as in the second example shown inn FIGS. 16A to 16C, and an antenna 136 is provided at a certain position. At a portion of the housing 190 opposing to the antenna 136, a dielectric transmission line 9A is formed from a dielectric material as the wireless signal transmission line 9. In the housing 290 of the image reproduction apparatus 201K incorporated in the receiving table 5K, a semiconductor chip 203 is accommodated, for example, similarly as in the second example shown in FIGS. 16A to 16C, and an antenna 236 is provided at a certain position. At a portion of the housing 290 opposing to the antenna 236, the wireless signal transmission line 9, that is, the dielectric transmission line 9A, is configured from a dielectric material. These points are similar to those in the second example described hereinabove.

The third example adopts not an idea of a fitting structure but a wall face abutting method and is configured such that, when the image acquisition apparatus 101K is placed in an abutment with a corner 101a of the receiving table 5K, the antenna 136 and the antenna 236 are opposed to each other. Therefore, an influence of positional displacement can be eliminated with certainty. By this configuration, when the image reproduction apparatus 201K is placed or mounted on the receiving table 5K, positioning of the image reproduction apparatus 201K for radio signal transmission can be carried out. Although the housing 190 and the housing 290 are interposed between the antenna 136 and the antenna 236, since they are made of a dielectric material, they do not have a significant influence on wireless transmission in the millimeter waveband.

While the disclosed technology has been described in connection with various working examples, the technical scope of the disclosed technology is not limited to the scope of the working examples. Various modifications and improvements can be applied to the working examples without departing from the spirit and scope of the disclosed technology, and also forms which include such modifications or improvements are included in the technical scope of the disclosed technology.

For example, while, in the working examples described hereinabove, many functioning sections are formed in a semiconductor integrated circuit or chip, this is not essentially required.

Further, while, in the working examples described hereinabove, phase correction of a reference clock is carried out by the clock production section 7004 on the reception side, since the positional relationship is a relative relationship between the transmission side and the reception side, the phase correction may otherwise be carried out by the clock production section 7002 side or may be carried out by both of the transmission side and the reception side. However, in the case where the communication apparatus is configured as that of the 1:N type wherein a plurality of or N receivers are provided for one transmitter, phase correction is carried out preferably by each receiver in response to a respective propagation delay without carrying out phase correction on the transmission side.

While, in the working examples, transmission of a reference signal from the reference signal transmission device 5 to the reference signal reception device 7 is carried out by wireless transmission, particularly by radio waves, the transmission is not limited to this, but optical communication utilizing, for example, a laser beam or wire communication may be used instead.

While, in the working examples, the frequency of a reference signal transmitted from the reference signal transmission device 5 to the reference signal reception device 7 is equal to that of the symbol periodic signal Sig1, this is not essential, but the frequency of the reference signal may be an integral submultiple, an integral number of times or N/M times (M and N are integers) of the symbol periodic signal Sig1. In those cases, correction against displacement from the frequency of the symbol periodic signal Sig1 may be carried out by the reference signal reception device 7 side that is, by the clock production section 7002 or the clock production section 7004. In the case of an integral submultiple, a reference clock received by the reference signal reception device 7 side is multiplied to produce the symbol periodic signal Sig1. Meanwhile, in the case of an integral number of times or N/M times, since a frequency dividing operation is included in production of the symbol periodic signal Sig1, a phenomenon called phase uncertainty may possibly occur that, even if the frequency of the symbol periodic signal Sig1 produced on the reception side is equal or frequency synchronism is established and besides the phase is locked or phase synchronism is established, the phase of the symbol periodic signal Sig1 does not become same. In an apparatus wherein only it is necessary for frequency synchronism and phase synchronism to be established, even if phase uncertainty exists, there is no problem. However, in the signal transmission apparatus 1 described in connection with the working examples in which communication adopting the code division multiplexing method is carried out, the phase uncertainty may possibly become a problem. Therefore, a countermeasure is required. However, description of the countermeasure is omitted herein.

The present disclosure contains subject matter related to that disclosed in Japanese Priority Patent Application JP 2010-202204 filed in the Japan Patent Office on Sep. 9, 2010, the entire content of which is hereby incorporated by reference.

What is claimed is:

1. A signal transmission apparatus, comprising:
a reference signal outputting section adapted to output a reference signal;
a first clock production section adapted to produce, based on the reference signal outputted from said reference signal outputting section, a first clock signal for a first signal process regarding a radio communication process of a spectrum spreading method in synchronism with the reference signal;
a first signal processing section adapted to carry out the first signal process based on the first clock signal produced by said first clock production section;
a second clock production section adapted to produce, based on the reference signal outputted from said reference signal outputting section, a second clock signal for a second signal process corresponding to the first signal process in synchronism with the reference signal; and
a second signal processing section adapted to carry out the second signal process based on the second clock signal produced by said second clock production section.

2. The signal transmission apparatus according to claim 1, wherein:
said first signal processing section includes
a first spread code string generation section adapted to produce a first spread code string in synchronism with the first clock signal produced by said first clock production section, and
a spreading processing section adapted to carry out a spreading process of transmission object data based on the first spread code string produced by said first spread code generation section as the first signal process; and
said second signal processing section includes
a second spread code string generation section adapted to produce a second spread code string in synchronism with the second clock signal produced by said second clock production section, and
a despreading processing section adapted to carry out a despreading process of reception data based on the second spread code string produced by said second spread code string generation section as the second signal process.

3. A signal transmission apparatus, comprising:
a first signal processing section adapted to carry out a first signal process regarding a radio communication process of a spectrum spreading method based on a reference signal;
a reference signal outputting section adapted to output the reference signal to be inputted to said first signal processing section;
a clock production section adapted to produce, based on the reference signal outputted from said reference signal outputting section, a clock signal for a second signal process corresponding to the first signal process in synchronism with the reference signal; and
a second signal processing section adapted to carry out the second signal process based on the clock signal produced by said clock production section.

4. The signal transmission apparatus according to claim 3, wherein:
said first signal processing section includes
a first spread code string generation section adapted to produce a first spread code string in synchronism with the reference signal, and
a spreading processing section adapted to carry out a spreading process of transmission object data based on the first spread code string produced by said first spread code string generation section as the first signal process; and
said second signal processing section includes
a second spread code string generation section adapted to produce a second spread code string in synchronism with the clock signal produced by said clock production section, and
a despreading processing section adapted to carry out a despreading process of reception data based on the second spread code string produced by said second spread code string generation section as the second signal process.

5. A signal transmission apparatus, comprising:
a reference signal outputting section adapted to output a reference signal;
a clock production section adapted to produce, based on the reference signal outputted from said reference signal outputting section, a clock signal for a signal process regarding a radio communication process of a spectrum spreading method in synchronism with the reference signal; and
a signal processing section adapted to carry out the signal process based on the clock signal produced by said clock production section.

6. The signal transmission apparatus according to claim 1, wherein said clock production section carries out phase correction in accordance with a correction amount determined based on a communication environment characteristic.

7. The signal transmission apparatus according to claim 1, wherein said clock production section produces a clock signal of a symbol period based on the reference signal outputted from said reference signal outputting section.

8. The signal transmission apparatus according to claim 7, wherein said reference signal outputting section outputs the reference signal having a frequency equal to the frequency of a symbol period.

9. The signal transmission apparatus according to claim 1, further comprising:
a modulation section including
a first carrier signal production section for producing a first carrier signal and adapted to modulate the signal outputted from said first signal processing section with the first carrier signal produced by said first carrier signal production section; and
a demodulation section including
a second carrier signal production section for producing a second carrier signal and adapted to demodulate a signal outputted from said modulation section with the second carrier signal produced by said second carrier signal production section,
at least one of said first carrier signal production section and said second carrier signal production section producing, based on the reference signal outputted from said reference signal outputting section, the carrier signal in synchronism with the reference signal.

10. The signal transmission apparatus according to claim 9, wherein at least one of said first carrier signal production section and said second carrier signal production section produces the carrier signal in synchronism with the reference signal by an injection locking method.

11. An electronic instrument, comprising:
a reference signal outputting section adapted to output a reference signal;
a first clock production section adapted to produce, based on the reference signal outputted from said reference signal outputting section, a first clock signal for a first signal process regarding a radio communication process of a spectrum spreading method in synchronism with the reference signal;
a first signal processing section adapted to carry out the first signal process based on the first clock signal produced by said first clock production section;
a second clock production section adapted to produce, based on the reference signal outputted from said reference signal outputting section, a second clock signal for a second signal process corresponding to the first signal process in synchronism with the reference signal;
a second signal processing section adapted to carry out the second signal process based on the second clock signal produced by said second clock production section;
a radio signal transmission line adapted to allow radio communication between said first signal processing section and said second signal processing section; and
a single housing in which said reference signal outputting section, first clock production section, first signal processing section, second clock production section, second signal processing section and radio signal transmission line are accommodated.

12. An electronic instrument, comprising:
a first electronic instrument including
a first clock production section adapted to produce, based on a reference signal, a first clock signal for a first signal process regarding a radio communication process of a spectrum spreading method in synchronism with the reference signal,
a first signal processing section adapted to carry out a first signal process based on the first clock signal produced by said first clock production section, and
a single housing in which said first clock production section and said first signal processing section are accommodated; and
a second electronic instrument including
a second clock production section adapted to produce, based on the reference signal, a second clock signal for a second signal process corresponding to the first signal process in synchronism with the reference signal,
a second signal processing section adapted to carry out a second signal process based on the second clock signal produced by said second clock production section, and
a single housing in which said second clock production section and said second signal processing section are accommodated; and
a radio signal transmission line, which allows radio transmission between said first signal processing section and said second signal processing section, being formed when said first electronic instrument and said second electronic instrument are disposed at predetermined positions.

13. The electronic instrument according to claim 12, further comprising:
a reference signal outputting section adapted to output the reference signal, said reference signal outputting section being accommodated in said housing of one of said first electronic instrument and said second electronic instrument.

14. An electronic instrument, comprising:
a first signal processing section adapted to carry out a first signal process regarding a radio communication process of a spectrum spreading method based on a reference signal;
a reference signal outputting section adapted to output the reference signal to be inputted to said first signal processing section;
a clock production section adapted to produce, based on the reference signal outputted from said reference signal outputting section, a clock signal for a second signal process corresponding to the first signal process in synchronism with the reference signal;
a second signal processing section adapted to carry out the second signal process based on the clock signal produced by said clock production section;
a radio signal transmission line adapted to allow radio communication between said first signal processing section and said second signal processing section; and
a single housing in which said first signal processing section, reference signal outputting section, clock production section, second signal processing section and radio signal transmission line are accommodated.

15. An electronic instrument, comprising:
a first electronic instrument including
a first signal processing section adapted to carry out, based on a reference signal, a first signal process regarding a radio communication process of a spectrum spreading method, and
a single housing in which said first signal processing section is accommodated; and
a second electronic instrument including
a clock production section adapted to produce, based on the reference signal, a clock signal for a second signal process corresponding to the first signal process in synchronism with the reference signal,
a second signal processing section adapted to carry out a second signal process based on the clock signal produced by said clock production section, and
a single housing in which said clock production section and said second signal processing section are accommodated; and
a radio signal transmission line, which allows radio transmission between said first signal processing section and said second signal processing section, being formed when said first electronic instrument and said second electronic instrument are disposed at predetermined positions.

16. A reference signal outputting apparatus, comprising:
a reference signal outputting section adapted to produce a reference signal to be used for production of a clock signal for a signal process regarding a radio communication process of a spectrum spreading method and output the reference signal to a communication apparatus.

17. A communication apparatus, comprising:
a reference signal outputting section adapted to output a reference signal;
a clock production section adapted to produce, based on the reference signal outputted from said reference signal outputting section, a clock signal for a signal process regarding a radio communication process of a spectrum spreading method in synchronism with the reference signal; and
a signal processing section adapted to carry out the signal process based on the clock signal produced by said clock production section.

18. A reference signal reception apparatus, comprising:
a clock production section adapted to receive a reference signal to be used for production of a clock signal for a signal process regarding a radio communication process of a spectrum spreading method and produce a clock signal synchronized with the reference signal.

19. A communication apparatus, comprising:
a clock production section adapted to receive a reference signal to be used for production of a clock signal for a signal process regarding a radio communication process of a spectrum spreading method and produce a clock signal synchronized with the reference signal; and
a signal processing section adapted to carry out the signal process based on the clock signal produced by said clock production section.

20. A signal transmission method, comprising:
receiving a reference signal to be used for production of a clock signal for a signal process regarding a radio communication process of a spectrum spreading method;
producing, based on the received reference signal, a clock signal for the signal process regarding the radio communication process of the spectrum spreading method; and
wirelessly transmitting a transmission object signal by the spectrum spreading method based on the produced clock signal.
